(19) United States
(12) Patent Application Publication
(10) Pub. No.: US 2003/0016871 A1
(43) Pub. Date: Jan. 23, 2003

(54) Image-effect method and image-effect apparatus

(76) Inventors: Yoshihisa Shinagawa, Tokyo (JP); Hiroki Nagashima, Tokyo (JP)

Correspondence Address: Dowell & Dowell, P.C., Suite 309, 1215 Jefferson Davis Highway, Arlington, VA, 22202, US

(21) Appl. No.: 10/013,489

(22) Filed: Dec. 13, 2001

(30) Foreign Application Priority Data
Dec. 20, 2000 (JP) 2000-386421

(51) Int. Cl. G06K 9/68

(52) U.S. Cl. 382/218

(57) ABSTRACT

An image input unit acquires a first image and a second image. A region setting unit sets a first region within the first image and a second region within the second image. A matching processor performs a matching computation between the first image and the second image. More specifically, the matching processor performs the matching computation between the first image and the second image using an internal constraint process for constraining the first region to be more likely to correspond to the second region.

### BACKGROUND OF THE INVENTION

1. Field of the Invention

The present invention relates to image-effect techniques and more particularly relates to a method and apparatus for digital image effects.

2. Description of the Related Art

As a part of the digital revolution, many users have come to enjoy services on the Internet from personal computers and portable telephones. The digital revolution is now spreading to broadcast services and movies, including digital satellite broadcasts. Thus, a barrier that had previously existed between broadcasting and communications is quickly beginning to disappear. Moreover, as broadband communications grow, multimedia content and culture will experience significant development, and, as a part of this multimedia culture, the distribution of video or motion pictures will become a key technology.

When humans acquire information from the outside world, images are capable of conveying much more information than audio. Besides being used for entertainment and recreational purposes, it is believed that images will also serve as a vital part of a software infrastructure which will support a wide range of aspects of human life and culture. As images are used more and more in a digital form, image-effect technology will expand into many fields with additional applications in computer graphics (CG) and image processing technologies.

Various image effects have been proposed and used in image processing. For example, known effects include slow motion, walk-through, multi-viewpoint image, special filtering, pseudo stereoscopic vision and so forth. However, many of these effects require expensive equipment that may be difficult to operate or require extensive human input or provide only low quality output. As the importance of images grows in the future, it is important that these and other image effects be provided with efficiency, cost-effectiveness and improved quality.

Conventionally, many kinds of visual effect on images such as walkthrough, multi-view image, specific filtering, and stereoscopy have been proposed and utilized. The more the image technology becomes important in society, the more it is required that these visual effects on the images are provided with higher quality and for communication, with high compressibility.

### SUMMARY OF THE INVENTION

The present invention has been made in view of the foregoing circumstances and an object of the present invention is to provide a new image-effect technique, method and apparatus which allows generation of high-quality smooth morphing or motion pictures using a relatively small amount of data.

Although, the present invention relates to an image-effect technology, the use of the technology is not limited to image effects only. For example, the described embodiments also provide compression of motion pictures and this use lies within the scope of the present invention.

An embodiment according to the present invention relates to an image-effect method. This method includes: acquiring a first image and a second image; setting a first region within the first image and a second region within the second image; and detecting matching between the first image and the second image using an internal constraint process for constraining the first region to be more likely to correspond to the second region.

In a particular case, the detecting may include a pixel-by-pixel matching computation between the first image and the second image.

Further, the pixel-by-pixel matching computation may be based on correspondence between a first critical point and a second critical point, wherein the first critical point and the second critical point are respectively detected through two-dimensional searches on the first image and the second image. In a particular case, the matching computation is not necessarily performed for all pixels.

Still further, the detecting may also include obtaining a multiresolutional image of the first image and the second image by respectively extracting the first critical point and the second critical point, and performing the pixel-by-pixel matching computation between the first image and the second image by beginning at a courser resolution level and then performing a pixel-by-pixel matching computation at a same resolution level while inheriting a result of a pixel-by-pixel matching computation at a different resolution level to acquire a pixel-by-pixel correspondence at a finest resolution level.

Moreover, the image-effect method may further include generating an intermediate image between the first image and the second image by performing an interpolation computation.

In the above method, the internal constraint process may include changing an attribute of pixels inside of the first region and the second region such that the attribute of pixels inside of the first region and the second region are different from the attribute of pixels outside of the first region and the second region.

Alternatively, the internal constraint process may include changing an attribute of pixels outside of the first region and the second region such that the attribute of pixels inside of the first region and the second region are different from the attribute of pixels inside of the first region and the second region.

As another alternative, the internal constraint process may include awarding a penalty when a pixel inside of the first region corresponds to a pixel outside of the second region, and the detecting may include performing an energy computation with the penalty being taken into consideration.

Further alternatively, the internal constraint process may include awarding a penalty when a pixel inside of the second region corresponds to a pixel outside of the first region, and the detecting may include performing an energy computation with the penalty being taken into consideration. In particular, if the detecting is based on whether the energy level of the two compared pixels is low or not, the penalty may be to add a high value to the energy level. In this case, the energy to be added may be infinite.

Still further alternatively, if multiresolutional images of the first image and of the second image have been prepared, the internal constraint process may include limiting a pixel-by-pixel correspondence at a coarser resolution level so that a pixel inside of the first region and a pixel inside of the second region are likely to correspond to each other at a finer resolution level.

Another embodiment of the present invention relates to an image-effect apparatus. The image-effect apparatus includes: an image input unit which acquires a first image and a second image; a region setting unit which sets a first region within the first image and a second region within the second image; and a matching processor which performs a matching computation between the first image and the second image. In particular, the matching processor performs the matching computation between the first image and the second image using an internal constraint process for constraining the first region to be more likely to correspond to the second region.

In a particular case, the matching processor may perform the pixel-by-pixel matching computation based on correspondence between a first critical point and a second critical point, wherein the first critical point and the second critical point are detected through two-dimensional searches on the first image and the second image, respectively.

Further, the matching processor may obtain a multiresolutional image of the first image and the second image by respectively extracting the first critical point and the second critical point, and perform the pixel-by-pixel matching computation by beginning at a courser resolution level and then performing a pixel-by-pixel matching computation at a same resolution level while inheriting a result of a pixel-by-pixel matching computation at a different resolution level to acquire a pixel-by-pixel correspondence at a finest resolution level.

In a particular case, the matching processor may generate a corresponding point file based on the matching computation and the apparatus may further include a communication unit which transmits the corresponding point file to an external device.

Still another embodiment of the present invention relates to a compute—program executable by a computer. The program includes functions of: acquiring a first region and a second region respectively set within a first image and a second image; and detecting matching between the first image and the second image using an internal constraint process for constraining the first region to be more likely to correspond to the second region.

The present invention is effective as image morphing technology. In addition, when taking the first image and the second image as frames in motion pictures, the present invention can be understood as a compression technology for motion pictures, since the corresponding point file can be quite small. This provides benefits in transmitting and storing motion pictures.

It is to be noted that the base technology is not a prerequisite in the present invention. Moreover, it is also possible to have replacement or substitution of the above-described structural components and elements of methods in part or whole as between method and apparatus or to add elements to either method or apparatus. Also, the apparatuses and methods may be implemented by a computer program and saved on a recording medium or the like and are all effective as and encompassed by the present invention.

Moreover, this summary of the invention includes features that may not be necessary features such that an embodiment of the present invention may also be a sub-combination of these described features.

### BRIEF DESCRIPTION OF THE DRAWINGS

FIG. 1(a) is an image obtained as a result of the application of an averaging filter to a human facial image.

FIG. 1(b) is an image obtained as a result of the application of an averaging filter to another human facial image.

FIG. 1(c) is an image of a human face at p^{(5,0)} obtained in a preferred embodiment in the base technology.

FIG. 1(d) is another image of a human face at p^{(5,0)} obtained in a preferred embodiment in the base technology.

FIG. 1(e) is an image of a human face at p^{(5,1)} obtained in a preferred embodiment in the base technology.

FIG. 1(f) is another image of a human face at p^{(5,1)} obtained in a preferred embodiment in the base technology.

FIG. 1(g) is an image of a human face at p^{(5,2)} obtained in a preferred embodiment in the base technology.

FIG. 1(h) is another image of a human face at p^{(5,2)} obtained in a preferred embodiment in the base technology.

FIG. 1(i) is an image of a human face at p^{(5,3)} obtained in a preferred embodiment in the base technology.

FIG. 1(j) is another image of a human face at p^{(5,3)} obtained in a preferred embodiment in the base technology.

FIG. 2(R) shows an original quadrilateral.

FIG. 2(A) shows an inherited quadrilateral.

FIG. 2(B) shows an inherited quadrilateral.

FIG. 2(C) shows an inherited quadrilateral.

FIG. 2(D) shows an inherited quadrilateral.

FIG. 2(E) shows an inherited quadrilateral.

FIG. 3 is a diagram showing the relationship between a source image and a destination image and that between the m-th level and the (m−1)th level, using a quadrilateral.

FIG. 4 shows the relationship between a parameters η (represented by x-axis) and energy C_{f} (represented by y-axis).

FIG. 5(a) is a diagram illustrating determination of whether or not the mapping for a certain point satisfies the bijectivity condition through the outer product computation.

FIG. 5(b) is a diagram illustrating determination of whether or not the mapping for a certain point satisfies the bijectivity condition through the outer product computation.

FIG. 6 is a flowchart of the entire procedure of a preferred embodiment in the base technology.

FIG. 7 is a flowchart showing the details of the process at S1 in FIG. 6.

FIG. 8 is a flowchart showing the details of the process at S10 in FIG. 7.

FIG. 9 is a diagram showing correspondence between partial images of the m-th and (m−1)th levels of resolution.

FIG. 10 is a diagram showing source images generated in the embodiment in the base technology.

FIG. 11 is a flowchart of a preparation procedure for S2 in FIG. 6.

FIG. 12 is a flowchart showing the details of the process at S2 in FIG. 6.

FIG. 13 is a diagram showing the way a submapping is determined at the 0-th level.

FIG. 14 is a diagram showing the way a submapping is determined at the first level.

FIG. 15 is a flowchart showing the details of the process at S21 in FIG. 6.

FIG. 16 is a graph showing the behavior of energy C_{f}^{(m,s)} corresponding to f^{(m,s)} (λ=iΔλ) which has been obtained for a certain f^{(m,s)} while changing λ.

FIG. 17 is a diagram showing the behavior of energy C_{f}⁽ⁿ⁾ corresponding to f⁽ⁿ⁾ (η=iΔη)(i=0,1, . . . ) which has been obtained while changing η.

FIG. 18 is a diagram illustrating a first region and a second region set within a first image and a second image, respectively.

FIG. 19 is a flowchart showing the process performed by an image-effect apparatus according to a present embodiment.

FIG. 20 shows a structure of an image-effect apparatus according to the present embodiment.

FIG. 21 is a diagram illustrating the process in the mode M3.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

First, the multiresolutional critical point filter technology and the image matching processing using the technology, both of which will be utilized in the preferred embodiments, will be described in detail as “Base Technology”. Namely, the following sections [1] and [2] (below) belong to the base technology, where section [1] describes elemental techniques and section [2] describes a processing procedure. These techniques are patented under Japanese Patent No. 2927350 and owned by the same assignees of the present invention. However, it is to be noted that the image matching techniques provided in the present embodiments are not limited to the same levels. In particular, in FIGS. 18 to 20, image effect and image interpolation techniques and apparatus representing embodiments of the present invention and utilizing the base technology will be described in more detail.

Base Technology

[1] Detailed description of elemental techniques

[1.1] Introduction

Using a set of new multiresolutional filters called critical point filters, image matching is accurately computed. There is no need for any prior knowledge concerning the content of the images or objects in question. The matching of the images is computed at each resolution while proceeding through the resolution hierarchy. The resolution hierarchy proceeds from a coarse level to a fine level. Parameters necessary for the computation are set completely automatically by dynamical computation analogous to human visual systems. Thus, There is no need to manually specify the correspondence of points between the images.

The base technology can be applied to, for instance, completely automated morphing, object recognition, stereo photogrammetry, volume rendering, and smooth generation of motion images from a small number of frames. When applied to morphing, given images can be automatically transformed. When applied to volume rendering, intermediate images between cross sections can be accurately reconstructed, even when a distance between cross sections is rather large and the cross sections vary widely in shape.

[1.2] The hierarchy of the critical point filters

The multiresolutional filters according to the base technology preserve the intensity and location of each critical point included in the images while reducing the resolution. Initially, let the width of an image to be examined be N and the height of the image be M. For simplicity, assume that N=M=2n where n is a positive integer. An interval [0, N] C R is denoted by 1. A pixel of the image at position (i, j) is denoted by p ^{(i,j)} where i,j ε I.

Here, a multiresolutional hierarchy is introduced. Hierarchized image groups are produced by a multiresolutional filter. The multiresolutional filter carries out a two dimensional search on an original image and detects critical points therefrom. The multiresolutinal filter then extracts the critical points from the original image to construct another image having a lower resolution. Here, the size of each of the respective images of the m-th level is denoted as 2^{m}×2^{m} (0<m<n). A critical point filter constructs the following four new hierarchical images recursively, in the direction descending from n.

p_{(i,j)}^{(m,0)}=min(min(p_{(2i,2j)}^{(m+1,0)},p_{(2i,2j+1)}^{(m+1,0)}), min(p_{(2i+1,2j)}^{(m+1,0)},p_{(2i+1,2j+1)}^{(m+1,0)}))

p_{(i,j)}^{(m,1)}=max(min(p_{(2i,2j)}^{(m+1,1)},p_{(2i,2j+1)}^{(m+1,1)}), min(p_{(2i+1,2j)}^{(m+1,1)},p_{(2i+1,2j+1)}^{(m+1,1)}))

p_{(i,j)}^{(m,2)}=min(max(p_{(2i,2j)}^{(m+1,2)},p_{(2i,2j+1)}^{(m+1,2)}), max(p_{(2i+1,2j)}^{(m+1,2)},p_{(2i+1,2j+1)}^{(m+1,2)}))

p_{(i,j)}^{(m,3)}=max(max(p_{(2i,2j)}^{(m+1,3)},p_{(2i,2j+1)}^{(m+1,3)}), max(p_{(2i+1,2j)}^{(m+1,3)},p_{(2i+1,2j+1)}^{(m+1,3)})) (1)

where we let

p_{(i,j)}^{(n,0)}=p_{(i,j)}^{(n,1)}=p_{(i,j)}^{(n,2)}=p_{(i,j)}^{(n,3)}=p_{(i,j)} (2)

The above four images are referred to as subimages hereinafter. When min_{x≦t≦x+1} and max_{x≦t≦x+1} are abbreviated to α and β, respectively, the subimages can be expressed as follows:

p^{(m,0)}=α(x)α(y)p^{(m+1,0)}

p^{(m,1)}=α(x)β(y)p^{(m+1,1)}

p^{(m,2)}=β(x)α(y)p^{(m+1,2)}

p^{(m,2)}=β(x)β(y)p^{(m+1,3)}

Namely, they can be considered analogous to the tensor products of α and β. The subimages correspond to the respective critical points. As is apparent from the above equations, the critical point filter detects a critical point of the original image for every block consisting of 2×2 pixels. In this detection, a point having a maximum pixel value and a point having a minimum pixel value are searched with respect to two directions, namely, vertical and horizontal directions, in each block. Although pixel intensity is used as a pixel value in this base technology, various other values relating to the image may be used. A pixel having the maximum pixel values for the two directions, one having minimum pixel values for the two directions, and one having a minimum pixel value for one direction and a maximum pixel value for the other direction are detected as a local maximum point, a local minimum point, and a saddle point, respectively.

By using the critical point filter, an image (1 pixel here) of a critical point detected inside each of the respective blocks serves to represent its block image (4 pixels here) in the next lower resolution level. Thus, the resolution of the image is reduced. From a singularity theoretical point of view, α(x)α(y) preserves the local minimum point (minima point), β(x)β(y) preserves the local maximum point (maxima point), α(x)β(y) and β(x)α(y) preserve the saddle points.

At the beginning, a critical point filtering process is applied separately to a source image and a destination image which are to be matching-computed. Thus, a series of image groups, namely, source hierarchical images and destination hierarchical images are generated. Four source hierarchical images and four destination hierarchical images are generated corresponding to the types of the critical points.

Thereafter, the source hierarchical images and the destination hierarchical images are matched in a series of resolution levels. First, the minima points are matched using p^{(m,0)}. Next, the first saddle points are matched using p^{(m,1)} based on the previous matching result for the minima points. The second saddle points are matched using p^{(m,2)}. Finally, the maxima points are matched using p^{(m,3)}.

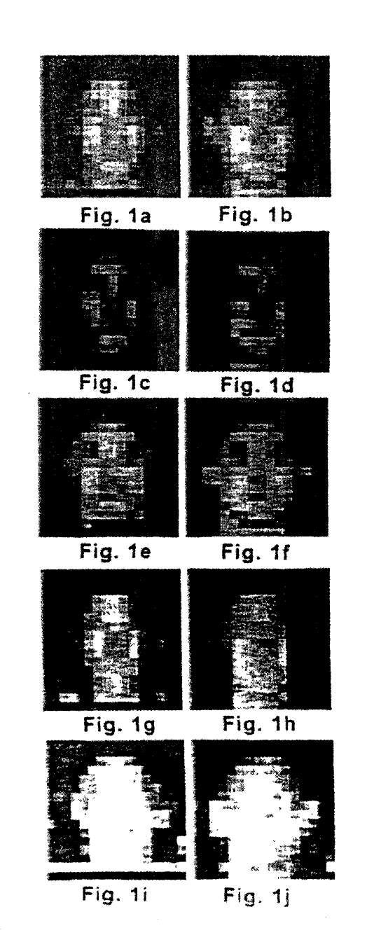

FIGS. 1c and 1d show the subimages p^{(5,0)} of the images in FIGS. 1a and 1b, respectively. Similarly, FIGS. 1e and 1f show the subimages p^{(5,1)}, FIGS. 1g and 1h show the subimages p^{(5,2)}, and FIGS. 1i and 1j show the subimages p^{(5,3)}. Characteristic parts in the images can be easily matched using subimages. The eyes can be matched by p^{(5,0)} since the eyes are the minima points of pixel intensity in a face. The mouths can be matched by p^{(5,1) since the mouths have low intensity in the horizontal direction. Vertical lines on both sides of the necks become clear by p}^{(5,2)}. The ears and bright parts of the cheeks become clear by p^{(5,3)} since these are the maxima points of pixel intensity.

As described above, the characteristics of an image can be extracted by the critical point filter. Thus, by comparing, for example, the characteristics of an image shot by a camera with the characteristics of several objects recorded in advance, an object shot by the camera can be identified.

[1.3] Computation of mapping between images

Now, for matching images, a pixel of the source image at the location (i, j) is denoted by p_{(i,j)}⁽ⁿ⁾ and that of the destination image at (k, l) is denoted by q_{(k,l)}⁽ⁿ⁾ where i, j, k, l ε I. The energy of the mapping between the images (described later in more detail) is then defined. This energy is determined by the difference in the intensity of the pixel of the source image and its corresponding pixel of the destination image and the smoothness of the mapping. First, the mapping f^{(m,0)}:p^{(m,0)}→q^{(m,0)} between p^{(m,0)} and q^{(m,0)} with the minimum energy is computed. Based on f^{(m,0)}, the mapping f^{(m,1)} between p^{(m,1)} and q^{(m,1)} with the minimum energy is computed. This process continues until f^{(m,3)} between p^{(m,3)} and q^{(m,3)} is computed. Each f^{(m,i)} (i=0,1,2, . . . ) is referred to as a submapping. The order of i will be rearranged as shown in the following equation (3) in computing f^{(m,i)} for reasons to be described later.

f^{(m,i)}:p^{(m,σ(i))}→q^{(m,σ(i))} (3)

where σ (i) ε {0,1,2,3}.

[1.3.1] Bijectivity

When the matching between a source image and a destination image is expressed by means of a mapping, that mapping shall satisfy the Bijectivity Conditions (BC) between the two images (note that a one-to-one surjective mapping is called a bijection). This is because the respective images should be connected satisfying both surjection and injection, and there is no conceptual supremacy existing between these images. It is to be noted that the mappings to be constructed here are the digital version of the bijection. In the base technology, a pixel is specified by a co-ordinate point.

The mapping of the source subimage (a subimage of a source image) to the destination subimage (a subimage of a destination image) is represented by f^{(m,s)}: I/2^{n-m}X I/2^{n-m}→I/2^{n-m}X I/2^{n-m} (s=0,1, . . . ), where f_{(i,j)}^{(m,s)}=(k, l) means that p_{(i,j)}^{(m,s)} of the source image is mapped to q_{k,l)}^{(m,s)} of the destination image. For simplicity, when f(i, j)=(k, l) holds, a pixel q_{(k,1)} is denoted by q_{f(i,j)}.

When the data sets are discrete as image pixels (grid points) treated in the base technology, the definition of bijectivity is important. Here, the bijection will be defined in the following manner, where i, j, k and l are all integers. First, a square region R defined on the source image plane is considered

p_{(i,j)}^{(m,s)}p_{(i+1,j)}^{(m,s)}p(i+1,j+1)^{(m,s)}p_{(i,j+1)}^{(m,s)} (4)

where i=0, . . . , 2^{m}−1, and j=0, . . . , 2^{m}−1. The edges of R are

directed as follows:

\overline{p_{(i,j)}^{(m,s)}p_{(i+1,j)}^{(m,s)}},\overline{p_{(i+1,j)}^{(m,s)}p_{(i+1,j+1)}^{(m,s)}},\overline{p_{(i+1,j+1)}^{(m,s)}p_{(i,j+1)}^{(m,s)}} and \overline{p_{(i,j+1)}^{(m,s)}p_{(i,j)}^{(m,s)}} (5)

This square region R will be mapped by f to a quadrilateral on the destination image plane:

q_{f(i,j)}^{(m,s)}q_{f(i+1,j)}^{(m,s)}q_{f(i+1,j+1)}^{(m,s)}q_{f(i,j+1)}^{(m,s)} (6)

This mapping f^{(m,s)} (R), that is,

f^{(m,s)}(R)=f^{(m,s)}(p_{(i,j)}^{(m,s)}p_{(i+1,j)}^{(m,s)}p_{(i+1,j+1)}^{(m,s)}p_{(i,j+1)}^{(m,s)}=q_{f(i,j)}^{(m,s)}q_{f(i+1,j)}^{(m,s)}q_{(i+1,j+1)}^{(m,s)}q_{f(i,j+1)}^{(m,s)})

should satisfy the following bijectivity conditions(referred to as BC hereinafter):

1. The edges of the quadrilateral f^{(m,s)} (R) should not intersect one another.

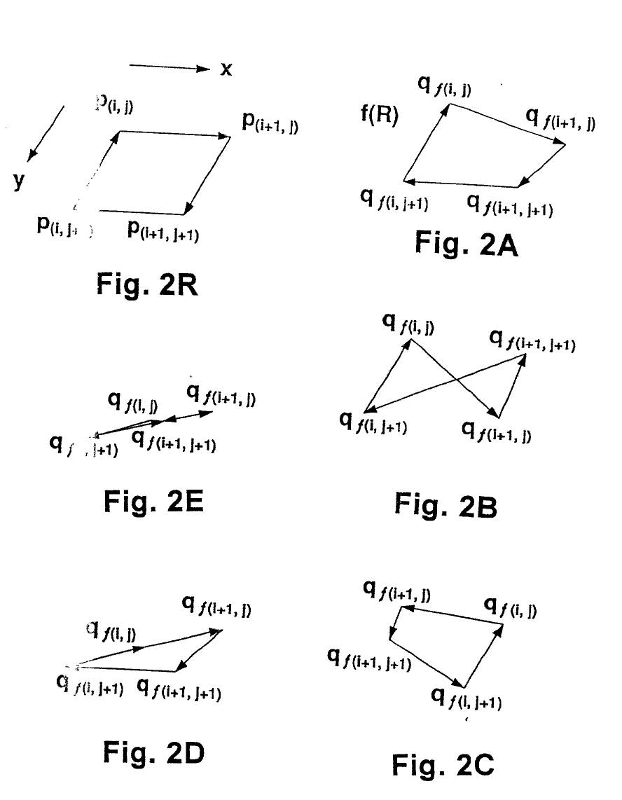

2. The orientation of the edges of f^{(m,s)} (R) should be the same as that of R (clockwise in the case shown in FIG. 2, described below).

3. As a relaxed condition, a retraction mapping is allowed.

Without a certain type of a relaxed condition as in, for example, condition 3 above, there would be no mappings which completely satisfy the BC other than a trivial identity mapping. Here, the length of a single edge of f^{(m,s)} (R) may be zero. Namely, f^{(m,s)} (R) may be a triangle. However, f^{(m,s)} (R) is not allowed to be a point or a line segment having area zero. Specifically speaking, if FIG. 2R is the original quadrilateral, FIGS. 2A and 2D satisfy the BC while FIGS. 2B, 2C and 2E do not satisfy the BC.

In actual implementation, the following condition may be further imposed to easily guarantee that the mapping is surjective. Namely, each pixel on the boundary of the source image is mapped to the pixel that occupies the same location at the destination image. In other words, f(i,j)=(i,j) (on the four lines of i=0, i=2^{m}−1, j=0, j=2^{m}−1). This condition will be hereinafter referred to as an additional condition.

[1.3.2] Energy of mapping

[1.3.2.1] Cost related to the pixel intensity

The energy of the mapping f is defined. An objective here is to search a mapping whose energy becomes minimum. The energy is determined mainly by the difference in the intensity between the pixel of the source image and its corresponding pixel of the destination image. Namely, the energy C_{(i,j)}^{(m,s)} of the mapping f^{(m,s)} at (i, j) is determined by the following equation (7).

C_{(i,j)}^{(m,s)}=|V(p_{(i,j)}^{(m,s)})−V(q_{(i,j)}^{(m,s)})|² (7)

where V(p_{(i,j)}^{(m,s)}) and V(q_{f(i,j)}^{(m,s)}) are the intensity values of the pixels p_{(i,j)}^{(m,s)} and q_{f(i,j)}^{(m,s)}, respectively. The total energy C^{(m,s)} of f is a matching evaluation equation, and can be defined as the sum of C_{(i,j)}^{(m,s)} as shown in the following equation (8).

$${C}_{f}^{( m , s )} = {\sum }_{i = 0}^{i = {2}^{m}} {\sum }_{j = 0}^{j = {2}^{m} - 1} {C}_{( i , j )}^{( m , s )} \qquad ( 8 )$$

[1.3.2.2] Cost related to the locations of the pixel for smooth mapping

In order to obtain smooth mappings, another energy D_{f} for the mapping is introduced. The energy D_{f} is determined by the locations of p_{(i,j)}^{(m,s)} and q_{f(i,j)}^{(m,s)} (i=0, 1, . . . , 2^{m}−1=0, 1, . . . , 2^{m}−1), regardless of the intensity of the pixels. The energy D_{(i,j)}^{(m,s)} of the mapping f^{(m,s)} at a point (i, j) is determined by the following equation (9).

D_{(i,j)}^{(m,s)}=ηE_{0(i,j)}^{(m,s)}+E_{1(i,j)}^{(m,s)} (9)

where the coefficient parameter η which is equal to or greater than 0 is a real number. And we have

E_{0(i,j)}^{(m,s)}=∥(i,j)−f^{(m,s)}(i,j)∥² (10)

$${E}_{1 ( i , j )}^{( m , s )} = {\sum }_{{i}^{′} = i - 1}^{i} {\sum }_{{j}^{′} = j - 1}^{i} {‖ ( {f}^{( m , s )} ( i , j ) - ( i , j ) ) - ( {f}^{( m , s )} ( {i}^{′} , {j}^{′} ) - ( {i}^{′} , {j}^{′} ) ) ‖}^{2} / 4 \qquad ( 11 )$$

where

∥(x,y)∥=\sqrt{x²+y²} (12),

i′ and j′ are integers and f(i′,j′) is defined to be zero for i′<0 and j′<0. E₀ is determined by the distance between (i,j) and f(i,j). E₀ prevents a pixel from being mapped to a pixel too far away from it. However, as explained below, E₀ can be replaced by another energy function. E₁ ensures the smoothness of the mapping. E₁ represents a distance between the displacement of p(i,j) and the displacement of its neighboring points. Based on the above consideration, another evaluation equation for evaluating the matching, or the energy D_{f} is determined by the following equation:

$${D}_{f}^{( m , s )} = {\sum }_{i = 0}^{i = {2}^{m} - 1} {\sum }_{j = 0}^{j = {2}^{m} - 1} {D}_{( i , j )}^{( m , s )} \qquad ( 13 )$$

[1.3.2.3] Total energy of the mapping

The total energy of the mapping, that is, a combined evaluation equation which relates to the combination of a plurality of evaluations, is defined as λC_{f}^{(m,s)}+D_{f}^{(m,s)}, where λ≧0 is a real number. The goal is to detect a state in which the combined evaluation equation has an extreme value, namely, to find a mapping which gives the minimum energy expressed by the following:

$${min}_{f} \{ λ {C}_{f}^{( m , s )} + {D}_{f}^{( m , s )} \} \qquad ( 14 )$$

Care must be exercised in that the mapping becomes an identity mapping if λ=0 and η=0 (i.e., f^{(m,s)} (i,j)=(i,j) for all i=0, 1, . . . , 2^{m}−1 and j=0, 1, . . . , 2^{m}−1). As will be described later, the mapping can be gradually modified or transformed from an identity mapping since the case of λ=0 and η=0 is evaluated at the outset in the base technology. If the combined evaluation equation is defined as C_{f}^{(m,s)}+λD_{f}^{(m,s)} where the original position of λ is changed as such, the equation with λ=0 and η=0 will be C_{f}^{(m,s)} only. As a result thereof, pixels would randomly matched to each other only because their pixel intensities are close, thus making the mapping totally meaningless. Transforming the mapping based on such a meaningless mapping makes no sense. Thus, the coefficient parameter is so determined that the identity mapping is initially selected for the evaluation as the best mapping.

Similar to this base technology, differences in the pixel intensity and smoothness are considered in a technique called “optical flow” that is known in the art. However, the optical flow technique cannot be used for image transformation since the optical flow technique takes into account only the local movement of an object. However, global correspondence can also be detected by utilizing the critical point filter according to the base technology.

[1.3.3] Determining the mapping with multiresolution

A mapping fₘᵢₙ which gives the minimum energy and satisfies the BC is searched by using the multiresolution hierarchy. The mapping between the source subimage and the destination subimage at each level of the resolution is computed. Starting from the top of the resolution hierarchy (i.e., the coarsest level), the mapping is determined at each resolution level, and where possible, mappings at other levels are considered. The number of candidate mappings at each level is restricted by using the mappings at an upper (i.e., coarser) level of the hierarchy. More specifically speaking, in the course of determining a mapping at a certain level, the mapping obtained at the coarser level by one is imposed as a sort of constraint condition.

We thus define a parent and child relationship between resolution levels. When the following equation (15) holds,

$$( {i}^{′} , {j}^{′} ) = ( ⌊ \frac{i}{2} ⌋ , ⌊ \frac{j}{2} ⌋ ) , \qquad ( 15 )$$

where └x┘ denotes the largest integer not exceeding x, p_{(i′,j′)}^{(m-1,s)} and q_{(i′,j′)}^{(m-1,s)} are respectively called the parents of p_{(i,j)}^{(m,s)} and q_{(i,j)}^{(m,s)},. Conversely, p_{(i,j)}^{(m,s)} and q_{(i,j)}^{(m,s)} are the child of p_{(i′,j′)}^{(m-1,s)} and the child of q_{i′,j′)}^{(m-1,s)}, respectively. A function parent (i, j) is defined by the following equation (16):

$$parent ( i , j ) = ( ⌊ \frac{i}{2} ⌋ , ⌊ \frac{j}{2} ⌋ ) \qquad ( 16 )$$

Now, a mapping between p_{(i,j)}^{(m,s)} and q_{(k,l)}^{(m,s)} is determined by computing the energy and finding the minimum thereof. The value of f^{(m,s)} (i, j)=(k, l) is determined as follows using f(m−1,s) (m=1, 2, . . . , n). First of all, a condition is imposed that q_{(k,l)}^{(m,s)} should lie inside a quadrilateral defined by the following definitions (17) and (18). Then, the applicable mappings are narrowed down by selecting ones that are thought to be reasonable or natural among them satisfying the BC.

q_{g}_{^{(m,s)}}_{(i-1,j-1)}^{(m,s)}q_{g}_{^{(m,s)}}_{i-1,j+1)}^{(m,s)}q_{g}_{^{(m,s)}}_{i+1,j+1)}^{(m,s)}q_{g}_{^{(m,s)}}_{i+1,j-1)}^{(m,s)} (17)

where

g^{(m,s)}(i,j)=f^{(m-1,s)}(parent(i,j))+f^{(m-1,s)}(parent(i,j)+(1,1)) (18)

The quadrilateral defined above is hereinafter referred to as the inherited quadrilateral of p_{(i,j)}^{(m,s)}. The pixel minimizing the energy is sought and obtained inside the inherited quadrilateral.

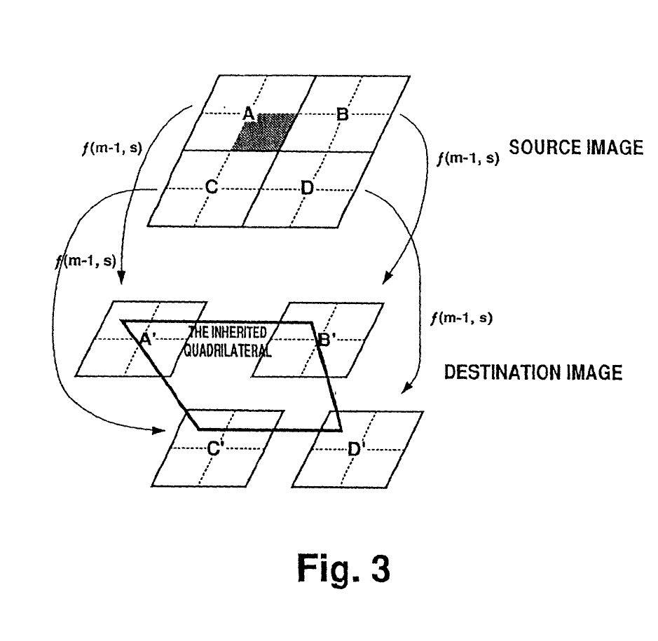

FIG. 3 illustrates the above-described procedures. The pixels A, B, C and D of the source image are mapped to A′, B′, C′ and D′ of the destination image, respectively, at the (m−1)th level in the hierarchy. The pixel p_{(i,j)}^{(m,s)} should be mapped to the pixel q_{f}_{^{(m)}}_{(i,j)}^{(m,s)} which exists inside the inherited quadrilateral A′B′C′D′. Thereby, bridging from the mapping at the (m−1)th level to the mapping at the m-th level is achieved.

The energy E₀ defined above may now be replaced by the following equations (19) and (20):

$$\begin{matrix}{E}_{0 ( i , j )} = {‖ {f}^{( m , 0 )} ( i , j ) - {g}^{( m )} ( i , j ) ‖}^{2 } & ( 19 ) \\ {E}_{0 ( i , j )} = {‖ {f}^{( m , s )} ( i , j ) - {f}^{( m , s - 1 )} ( i , j ) ‖}^{2 } , ( 1 \leq i ) & ( 20 )\end{matrix}$$

for computing the submapping f^{(m,0)} and the submapping f^{(m,s)} at the m-th level, respectively.

In this manner, a mapping which maintains a low energy of all the submappings is obtained. Using the equation (20) makes the submappings corresponding to the different critical points associated to each other within the same level in order that the subimages can have high similarity. The equation (19) represents the distance between f^{(m,s)} (i,j) and the location where (i,j) should be mapped when regarded as a part of a pixel at the (m−1)the level.

When there is no pixel satisfying the BC inside the inherited quadrilateral A′B′C′D′, the following steps are taken. First, pixels whose distance from the boundary of A′B′C′D′ is L (at first, L=1) are examined. If a pixel whose energy is the minimum among them satisfies the BC, then this pixel will be selected as a value of f^{(m,s)} (i,j). L is increased until such a pixel is found or L reaches its upper bound Lₘₐₓ^{(m)}. Lₘₐₓ^{(m)} is fixed for each level m. If no pixel is found at all, the third condition of the BC is ignored temporarily and such mappings that caused the area of the transformed quadrilateral to become zero (a point or a line) will be permitted so as to determine f^{(m,s)} (i,j). If such a pixel is still not found, then the first and the second conditions of the BC will be removed.

Multiresolution approximation is essential to determining the global correspondence of the images while preventing the mapping from being affected by small details of the images. Without the multiresolution approximation, it is impossible to detect a correspondence between pixels whose distances are large. In the case where the multiresolution approximation is not available, the size of an image will generally be limited to a very small size, and only tiny changes in the images can be handled. Moreover, imposing smoothness on the mapping usually makes it difficult to find the correspondence of such pixels. That is because the energy of the mapping from one pixel to another pixel which is far therefrom is high. On the other hand, the multiresolution approximation enables finding the approximate correspondence of such pixels. This is because the distance between the pixels is small at the upper (coarser) level of the hierarchy of the resolution.

[1.4] Automatic determination of the optimal parameter values

One of the main deficiencies of the existing image matching techniques lies in the difficulty of parameter adjustment. In most cases, the parameter adjustment is performed manually and it is extremely difficult to select the optimal value. However, according to the base technology, the optimal parameter values can be obtained completely automatically.

The systems according to this base technology include two parameters, namely, λ and η, where λ and η represent the weight of the difference of the pixel intensity and the stiffness of the mapping, respectively. In order to automatically determine these parameters, the are initially set to 0. First, λ is gradually increased from λ=0 while η is fixed at 0. As λ becomes larger and the value of the combined evaluation equation (equation (14)) is minimized, the value of C_{f}^{(m,s)} for each submapping generally becomes smaller. This basically means that the two images are matched better. However, if λ exceeds the optimal value, the following phenomena occur:

1. Pixels which should not be corresponded are erroneously corresponded only because their intensities are close.

2. As a result, correspondence between images becomes inaccurate, and the mapping becomes invalid.

3. As a result, D_{f}^{(m,s)} in equation (14) tends to increase abruptly.

4. As a result, since the value of equation (14) tends to increase abruptly, f^{(m,s)} changes in order to suppress the abrupt increase of f^{(m,s)}. As a result, C_{f}^{(m,s)} increases.

Therefore, a threshold value at which C_{f}^{(m,s)} turns to an increase from a decrease is detected while a state in which equation (14) takes he minimum value with λ being increased is kept. Such λ is determined as the optimal value at η=0. Next, the behavior of C_{f}^{(m,s)} is examined while η is increased gradually, and η will be automatically determined by a method described later. λ will then again be determined corresponding to such an automatically determined η.

The above-described method resembles the focusing mechanism of human visual systems. In the human visual systems, the images Of the respective right eye and left eye are matched while moving one eye. When the objects are clearly recognized, the moving eye is fixed.

[1.4.1] Dynamic determination of λ

Initially, λ is increased from 0 at a certain interval, and a subimage is evaluated each time the value of λ changes. As shown in equation (14), the total energy is defined by λC_{f}^{(m,s)}+D_{f}^{(m,s)}. D_{(i,j)}^{(m,s)} in equation (9) represents the smoothness and theoretically becomes minimum when it is the identity mapping. E₀ and E₁ increase as the mapping is further distorted. Since E₁ is an integer, 1 is the smallest step of D_{f}^{(m,s)}. Thus, it is impossible to change the mapping to reduce the total energy unless a changed amount (reduction amount) of the current λC_{(i,j)}^{(m,s)} is equal to or greater than 1. Since D_{f}^{(m,s)} ms increases by more than 1 accompanied by the change of the mapping, the total energy is not reduced unless λC_{(i,j)}^{(m,s)} is reduced by more than 1.

Under this condition, it is shown that C_{(i,j)}^{(m,s)} decreases in normal cases as λ increases. The histogram of C_{(i,j)}^{(m,s)} is denoted as h(l), where h(l) is the number of pixels whose energy C_{(i,j)}^{(m,s)} 1². In order that λ1²>1 for example, the case of 1²=1/λ is considered. When λ varies from λ₁ to λ₂, a number of pixels (denoted A) expressed by the following equation (21):

$$A = {\sum }_{l = ⌈ \frac{1}{{λ}_{2}} ⌉}^{⌊ \frac{1}{{λ}_{1}} ⌋} h ( l ) ≅ {\int }_{l = \frac{1}{{λ}_{2}}}^{\frac{1}{{λ}_{1}}} h ( l ) ⅆ l = - {\int }_{{λ}_{2}}^{{λ}_{1}} h ( l ) \frac{1}{{λ}^{3 / 2}} ⅆ λ = {\int }_{{λ}_{1}}^{{λ}_{2}} \frac{h ( l )}{{λ}^{3 / 2}} ⅆ λ \qquad ( 21 )$$

changes to a more stable state having the energy shown in equation(22):

$${C}_{f}^{( m , s )} - {l}^{2} = {C}_{f}^{( m , s )} - \frac{1}{λ} . \qquad ( 22 )$$

Here, it is assumed that the energy of these pixels is approximated to be zero. This means that the value of C_{(i,j)}^{(m,s)} changes by:

$$\partial {C}_{f}^{( m , s )} = - \frac{A}{λ} \qquad ( 23 )$$

As a result, equation (24) holds.

$$\frac{\partial {C}_{f}^{( m , s )}}{\partial λ} = - \frac{h ( l )}{{λ}^{5 / 2}} \qquad ( 24 )$$

Since h(l)>0, C_{f}^{(m,s)} decreases in the normal case. However, when λ exceeds the optimal value, the above phenomenon, that is, an increase in C_{f}^{(m,s)} occurs. The optimal value of λ is determined by detecting this phenomenon.

When

$$h ( l ) = H {l}^{k} = \frac{H}{{λ}^{k / 2}} \qquad ( 25 )$$

is assumed, where both H(H>0) and k are constants, the equation (26) holds:

$$\frac{\partial {C}_{f}^{( m , s )}}{\partial λ} = - \frac{H}{{λ}^{5 / 2 + k / 2}} \qquad ( 26 )$$

Then, if k≠−3, the following equation (27) holds:

$${C}_{f}^{( m , s )} = C + \frac{H}{( 3 / 2 + k / 2 ) {λ}^{3 / 2 + k / 2}} \qquad ( 27 )$$

The equation (27) is a general equation of C_{f}^{(m,s)} (where C is a constant).

When detecting the optimal value of λ, the number of pixels violating the BC may be examined for safety. In the course of determining a mapping for each pixel, the probability of violating the BC is assumed as a value p₀ here. In this case, since

$$\frac{\partial A}{\partial λ} = \frac{h ( l )}{{λ}^{3 / 2}} \qquad ( 28 )$$

holds, the number of pixels violating the BC increases at a rate of:

$${B}_{0} = \frac{h ( l ) {p}_{0}}{{λ}^{3 / 2}} \qquad ( 29 )$$

Thus,

$$\frac{{B}_{0} {λ}^{3 / 2}}{{p}_{0} h ( l )} = 1 \qquad ( 30 )$$

is a constant. If it is assumed that h(l)=H1^{k}, the following equation (31), for example,

B₀λ^{3/2+k/2}=p₀H (31)

becomes a constant. However, when λ exceeds the optimal value, the above value of equation (31) increases abruptly. By detecting this phenomenon, i.e. whether or not the value of B₀λ^{3/2+k/2}/2′″ exceeds an abnormal value B₀ₜₕᵣₑₛ, the optimal value of λ can be determined. Similarly, whether or not the value of B₁λ3/2+k/2/2′″ exceeds an abnormal value B₁ₜₕᵣₑₛ can be used to check for an increasing rate B₁ of pixels violating the third condition of the BC. The reason why the factor 2^{m} is introduced here will be described at a later stage. This system is not sensitive to the two threshold values B₀ₜₕᵣₑₛ and B₁ₜₕᵣₑₛ. The two threshold values B₀ₜₕᵣₑₛ and B₁ₜₕᵣₑₛ can be used to detect excessive distortion of the mapping which may not be detected through observation of the energy C_{f}^{(m,s)}.

In the experimentation, when λ exceeded 0.1 the computation of f^{(m,s)} was stopped and the computation of f^{)m,s+1)} was started. That is because the computation of submappings is affected by a difference of only 3 out of 255 levels in pixel intensity when λ>0.1 and it is then difficult to obtain a correct result.

[1.4.2] Histogram h(l)

The examination of C_{f}^{(m,s)} does not depend on the histogram h(l), however, the examination of the BC and its third condition may be affected by h(l). When λ, C_{f}^{(m,s)}) is actually plotted, k is usually close to 1. In the experiment, k=1 is used, that is, B₀λ² and B₁λ² are examined. If the true value of k is less than 1, B₀λ² and B₁λ² are not constants and increase gradually by a factor of λ^{(1-k)/2}. If h(l) is a constant, the factor is, for example, λ^{1/2}. However, such a difference can be absorbed by setting the threshold B₀ₜₕᵣₑₛ appropriately.

Let us model the source image by a circular object, with its center at(x₀,y₀) and its radius r, given by:

$$p ( i , j ) = \{ \begin{matrix} \frac{255}{r} c ( \sqrt{{( i - {x}_{0} )}^{2} + {( j - {y}_{0} )}^{2}} … ( \sqrt{{( i - {x}_{0} )}^{2} + {( j - {y}_{0} )}^{2}} \leq r ) \\ 0 … ( otherwise )\end{matrix} \qquad ( 32 )$$

and the destination image given by:

$$q ( i , j ) = \{ \begin{matrix} \frac{255}{r} c ( \sqrt{{( i - {x}_{1} )}^{2} + {( j - {y}_{1} )}^{2}} ) … ( \sqrt{{( i - {x}_{1} )}^{2} + {( j - {y}_{1} )}^{2}} \leq r ) \\ 0 … ( o t h e r w i s e )\end{matrix} \qquad ( 33 )$$

with its center at (x₁,y₁) and radius r. In the above, let c(x) have the form of c(x)=x^{k}. When the centers (x₀, y₀) and (x₁, y₁) are sufficiently far from each other, the histogram h(l) is then in the form:

h(l)∝rl^{k}(k≠0) (34)

When k=1, the images represent objects with clear boundaries embedded in the background. These objects become darker toward their centers and brighter toward their boundaries. When k=−1, the images represent objects with vague boundaries. These objects are brightest at their centers, and become darker toward their boundaries. Without much loss of generality, it suffices to state that objects in images are generally between these two types of objects. Thus, choosing k such that −1≦k≦1 can cover most cases and the equation (27) is generally a decreasing function for this range.

As can be observed from the above equation (34), attention must be directed to the fact that r is influenced by the resolution of the image, that is, r is proportional to 2^{m}. This is the reason for the factor 2^{m} being introduced in the above section [1.4.1].

[1.4.3] Dynamic determination of η

The parameter η can also be automatically determined in a similar manner. Initially, η is set to zero, and the final mapping f⁽ⁿ⁾ and the energy C_{f}⁽ⁿ⁾ at the finest resolution are computed. Then, after η is increased by a certain value Δη, the final mapping f⁽ⁿ⁾ and the energy C_{f}⁽ⁿ⁾ at the finest resolution are again computed. This process is repeated until the optimal value of η is obtained. η represents the stiffness of the mapping because it is a weight of the following equation (35):

$${E}_{0 ( i , j )}^{( m , s )} = {‖ {f}^{( m , s )} ( i , j ) - {f}^{( m , s - 1 )} ( i , j ) ‖}^{2} \qquad ( 35 )$$

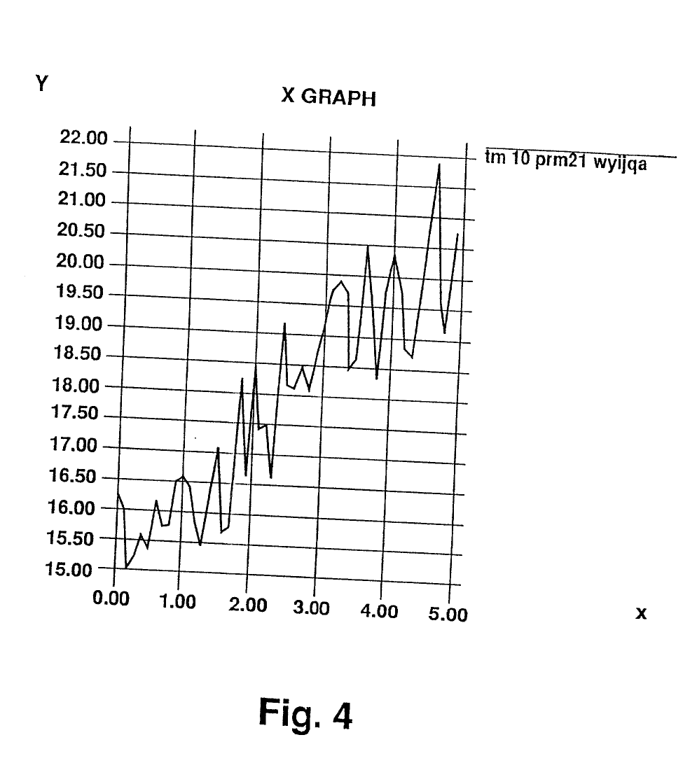

If η is zero, D_{f}⁽ⁿ⁾ is determined irrespective of the previous submapping, and the present submapping may be elastically deformed and become too distorted. On the other hand, if η is a very large value, D_{f}⁽ⁿ⁾ is almost completely determined by the immediately previous submapping. The submappings are then very stiff, and the pixels are mapped to almost the same locations. The resulting mapping is therefore the identity mapping. When the value of η increases from 0, C_{f}⁽ⁿ⁾ gradually decreases as will be described later. However, when the value of η exceeds the optimal value, the energy starts increasing as shown in FIG. 4. In FIG. 4, the x-axis represents η, and y-axis represents C_{f}.

The optimum value of η which minimizes C_{f}⁽ⁿ⁾ can be obtained in this manner. However, since various elements affect this computation as compared to the case of λ, C_{f}⁽ⁿ⁾ changes while slightly fluctuating. This difference is caused because a submapping is re-computed once in the case of λ whenever an input changes slightly, whereas all the submappings must be re-computed in the case of η. Thus, whether the obtained value of C_{f}⁽ⁿ⁾ is the minimum or not cannot be determined as easily. When candidates for the minimum value are found, the true minimum needs to be searched by setting up further finer intervals.

[1.5] Supersampling

When deciding the correspondence between the pixels, the range of f^{(m,s)} can be expanded to R×R (R being the set of real numbers) in order to increase the degree of freedom. In this case, the intensity of the pixels of the destination image is interpolated, to provide f^{(m,s)} having an intensity at non-integer points:

V(q_{f}_{^{(m,s)}}_{(i,j)}^{(m,s)} (36)

That is, supersampling is performed. In an example implementation, f^{(m,s)} may take integer and half integer values, and

V(q_{(i,j)+(0.5,0.5)}^{(m,s)} (37)

is given by

(V(q_{(i,j)}^{(m,s)})+V(q_{(i,j)+(k,l)}^{(m,s)}))/2 (38)

[1.6] Normalization, of the pixel intensity of each image

When the source and destination images contain quite different objects, the raw pixel intensity may not be used to compute the mapping because a large difference in the pixel intensity causes excessively large energy C_{f}^{(m,s)} and thus making it difficult to obtain an accurate evaluation.

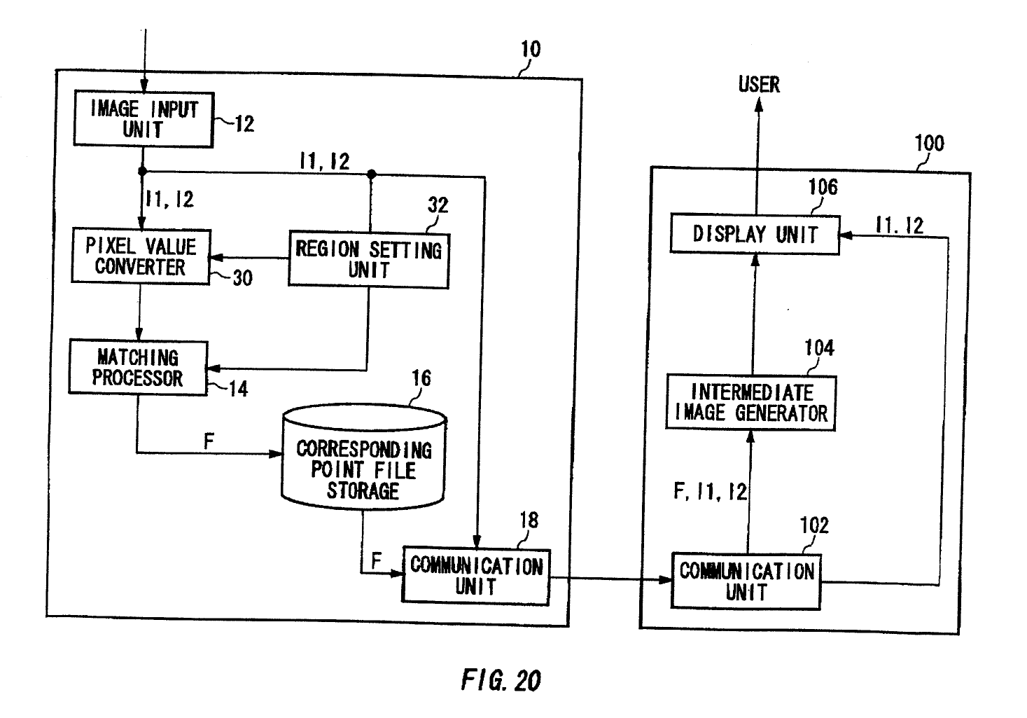

For example, a matching between a human face and a cat's face is computed as shown in FIGS. 20(a) and 20(b). The cat's face is covered with hair and is a mixture of very bright pixels and very dark pixels. In this case, in order to compute the submappings of the two faces, subimages are normalized. That is, the darkest pixel intensity is set to 0 while the brightest pixel intensity is set to 255, and other pixel intensity values are obtained using linear interpolation.

[1.7] Implementation

In an example implementation, a heuristic method is utilized wherein the computation proceeds linearly as the source image is scanned. First, the value of f_{(m,s)} is determined at the top leftmost pixel (i,j)=(0, 0). The value of each f^{(m,s)} (i,j) is then determined while i is increased by one at each step. When i reaches the width of the image, j is increased by one and i is reset to zero. Thereafter, f^{(m,s)} (i,j) is determined while scanning the source image. Once pixel correspondence is determined for all the points, it means that a single Mapping f^{(m,s)} is determined.

When a corresponding point q_{f(i,j)} is determined for p_{(i,j)}, a corresponding point q_{f(i,j+1)} of p_{(i,j+1)} is determined next. The position of q_{f(i,j+1) is constrained by the position of q}_{f(i,j)} since the position of q_{f(i,j+1)} satisfies the BC. Thus, in this system, a point whose corresponding point is determined earlier is given higher priority. If the situation continues in which (0,0) is always given the highest priority, the final mapping might be unnecessarily biased. In order to avoid this bias, f^{(m,s)} is determined in the following manner in the base technology.

First, when (s mod 4) is 0, f^{(m,s)} is determined starting from (0,0) while gradually increasing both i and j. When (s mod 4) is 1, f^{(m,s)} is determined starting from the top rightmost location while decreasing i and increasing j. When (s mod 4) is 2, f^{(m,s)} is determined starting from the bottom rightmost location while decreasing both i and j. When (s mod 4) is 3, f^{(m,s)} is determined starting from the bottom leftmost location while increasing i and decreasing j. Since a concept such as the submapping, that is, a parameter s, does not exist in the finest n-th level, f^{(m,s)} is computed continuously in two directions on the assumption that s=0 and s=2.

In this implementation, the values of f^{(m,s)} (i,j) (m=0, . . . , n) that satisfy the BC are chosen as much as possible from the candidates (k,l) by imposing a penalty on the candidates violating the BC. The energy D_{(k,l)} of a candidate that violates the third condition of the BC is multiplied by φ and that of a candidate that violates the first or second condition of the BC is multiplied by ψ. In this implementation, φ=2 and ψ−100000 are used.

In order to check the above-mentioned BC, the following test may be performed as the procedure when determining (k,l)=f^{(m,s)} (i,j). Namely, for each grid point (k,l) in the inherited quadrilateral of f^{(ms)} (i,j), whether or not the z-component of the outer product of

W=\vec{A}×\vec{B} (39)

is equal to or greater than 0 is examined, where

\vec{A}={overscore (q_{f}_{^{(m,s)}}_{(i,j-1)}^{(m,s)}q_{f}_{^{(m,s)}}_{i+1,j-1)}^{(m,s)})} (40)

\vec{B}={overscore (q_{f}_{^{(m,s)}}_{(i,j-1)}^{(m,s)}q_{(k,l)}^{(m,s)})} (41)

Here, the vectors are regarded as 3D vectors and the z-axis is defined in the orthogonal right-hand coordinate system. When W is negative, the candidate is imposed with a penalty by multiplying D_{(k,l)}^{(m,s)} by ψ so that it is not as likely to be selected.

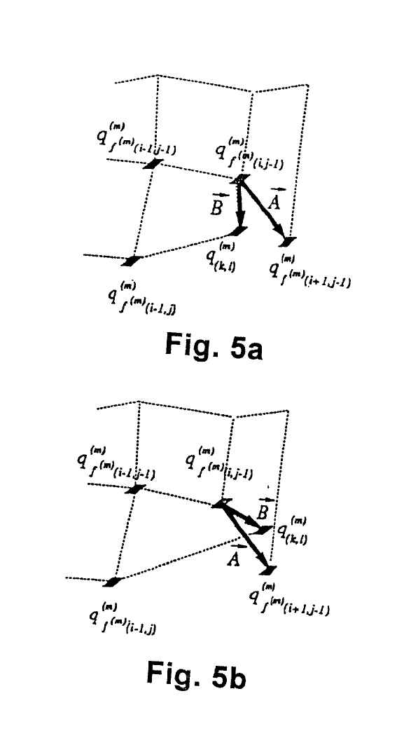

FIGS. 5(a) and 5(b) illustrate the reason why this condition is inspected. FIG. 5(a) shows a candidate without a penalty and FIG. 5(b) shows one with a penalty. When determining the mapping f^{(m,s)} (i, j+1) for the adjacent pixel at (i, j+1), there is no pixel on the source image plane that satisfies the BC if the z-component of W is negative because then q_{(k,l)}^{(m,s)} passes the )boundary of the adjacent quadrilateral.

[1.7.1] The order f submappings

In this implementation, σ(0)=0, σ(1)=1, (2)=2, σ(3)=3, σ(4)=0 are used when the resolution level is even, while σ(0)=3, σ(1)=2, σ(2)=1, σ(3)=0, σ(4)=3 are used when the resolution level is odd. Thus, the submappings are shuffled to some extent. It is to be noted that the submappings are primarily of four types, and s may be any of 0 to 3. However, a processing with s=4 is used in this implementation for a reason to be described later.

[1.8] Interpolations

After the mapping between the source and destination images is determined, the intensity values of the corresponding pixels are interpolated. In the implementation, trilinear interpolation is used. Suppose that a square p_{(i,j)}p_{(i+1,j)}p_{(i+1,j+)}p_{(i,j+)} on the source image plane is mapped to a quadrilateral q_{f(i,j)}q_{f(i+1,j)}q_{f(i+1,j+1)}q_{f(i,j+1)} on the destination image plane. For simplicity, the distance between the image planes is assumed to be 1. The intermediate image pixels r(x, y, t) (0≦x≦N−1, 0≦y≦M−1) whose distance from the source image plane is t (0≦t≦1) are obtained as follows. First, the location of the pixel r(x, y, t), where x, y, tεR, is determined by equation (42):

(x,y)=(1−dx)(1−dy)(1−t)(i,j)+(1−dx)(1−dy)tf(i,j) +dx(1−dy)(1−t)(i+1,j)+dx(1−dy)tf(i+1,j) +(1−dx)dy(1−t)(i,j+1)+(1−dx)dytf(i,j+1) +dxdy(1−t)(i+1,j+1)+dxdytf(i+1,j+1) (42)

The value of the pixel intensity at r(x, y, t) is then determined by equation (43):

V(r(x,y,t))=(1−dx)(1−dy)(1−t)V(p_{(i,j)})+(1−dx) (1−dy)tV(q_{(i,j)}) +dx(1−dy)(1−t)V(p_{(i+1,j)})+dx(1−dy)tV(q_{f(i+1,j)}) +(1−dx)dy(1−t)V(p_{(i,j+1)})+(1−dx)dytV(q_{f(i,j+1)}) +dxdy(1−t)V(p_{(i+1,j+1)})+dxdytV(q_{f(i+1,j+1)}) (43)

where dx and dy are parameters varying from 0 to 1.

[1.9] Mapping to which constraints are imposed

So far, the determination of a mapping in which no constraints are imposed has been described. However, if a correspondence between particular pixels of the source and destination images provided in a predetermined manner, the mapping can be determined using such correspondence as a constraint.

The basic idea is that the source image is roughly deformed by an approximate mapping which maps the specified pixels of the source image to the specified pixels of the destination image and thereafter a mapping f is accurately computed.

First, the specified pixels of the source image are mapped to the specified pixels of the destination image, then the approximate mapping that maps other pixels of the source image to appropriate locations are determined. In other words, the mapping is such that pixels in the vicinity of a specified pixel are mapped to locations near the position to which the specified one is mapped. Here, the approximate mapping at the m-th level in the resolution hierarchy is denoted by F^{(m)}.

The approximate mapping F is determined in the following manner. First, the mappings for several pixels are specified. When nₛ pixels

p(i₀,j₀),p(i₁,j₁), . . . ,p(iₙ_{ₛ}₋₁,jₙ_{ₛ}₋₁) (44)

of the source image are specified, the following values in the equation (45) are determined.

F⁽ⁿ⁾(i₀,j₀)=(k₀,l₀), F⁽ⁿ⁾(i₁,j₁)=(k₁,l₁), . . . , F⁽ⁿ⁾(iₙ_{ₛ}₋₁,jₙ_{ₛ}₋₁)=(kₙ_{ₛ}₋₁,lₙ_{ₛ}₋₁) (45)

For the remaining pixels of the source image, the amount of displacement is the weighted average of the displacement of p(iₕ, jₕ) (h=0, . . . , nₛ−1). Namely, a pixel p_{(i,j)} is mapped to the following pixel (expressed by the equation (46)) of the destination image.

$$\begin{matrix}{F}^{( m )} ( i , j ) = \frac{( i , j ) + {\sum }_{h = 0}^{h = {n}_{s} - 1} ( {k}_{h} - {i}_{h} , {l}_{h} - {j}_{h} ) w e i g h {t}_{h} ( i , j )}{{2}^{n - m}} \\ w h e r e & ( 46 ) \\ w e i g h {t}_{h} ( i , j ) = \frac{1 / {‖ ( {i}_{h} - i , {j}_{h} - j ) ‖}^{2}}{total\_weight ( i , j )} \\ w h e r e & ( 47 ) \\ total\_weight ( i , j ) = {\sum }_{h = 0}^{h = {n}_{s} - 1} 1 / {‖ ( {i}_{h} - i , {j}_{h} - j ) ‖}^{2} & ( 48 )\end{matrix}$$

Second, the energy D_{(i,j)}^{(m,s)} of the candidate mapping f is changed so that a mapping f similar to F^{(m)} has a lower energy. Precisely speaking, D_{(i,j)}^{(m,s)} is expressed by the equation (49):

D_{(i,j)}^{(m,s)}=E₀_{_{(i,j)}}^{(m,s)}+ηE₁_{_{(i,j)}}^{(m,s)}+κE₂_{_{(i,j)}}^{(m,s)} (49)

where

$${E}_{{2}_{( i , j )}}^{( m , s )} = \{ \begin{matrix}0 , & if {‖ {F}^{( m )} ( i , j ) - {f}^{( m , s )} ( i , j ) ‖}^{2} \leq ⌊ \frac{{ρ}^{2}}{{2}^{2 ( n - m )}} ⌋ \\ {‖ {F}^{( m )} ( i , j ) - {f}^{( m , s )} ( i , j ) ‖}^{2} , & otherwise\end{matrix} \qquad ( 50 )$$

where κ, ρ≧0. Finally, the resulting mapping f is determined by the above-described automatic computing process.

A Note that E₂_{_{(i,j)}}^{(m,s)} becomes 0 if f^{(m,s)} (i,j) is sufficiently close to F^{(m)} (i,j) i.e., the distance therebetween is equal to or less than

$$⌊ \frac{{ρ}^{2}}{{2}^{2 ( n - m )}} ⌋ \qquad ( 51 )$$

This has been defined in this way because it is desirable to determine each value f^{(m,s)} (i,j) automatically to fit in an appropriate place in the destination image as long as each value f^{(m,s)} (i,j) is close to F^{(m)} (i,j). For this reason, there is no need to specify the precise correspondence in detail to have the source image automatically mapped so that the source image matches the destination image.

[2] Concrete Processing Procedure

The flow of a process utilizing the respective elemental techniques described in [1] will now be described.

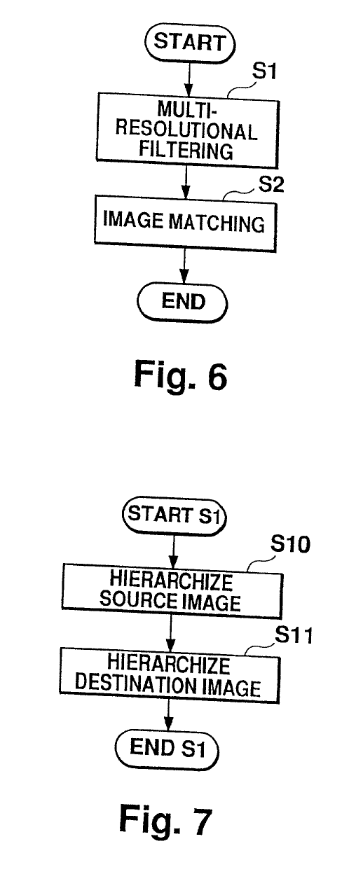

FIG. 6 is a flowchart of the overall procedure of the base technology. Referring to FIG. 6, a source image and destination image are first processed using a multiresolutional critical point filter (S1). The source image and the destination image are then matched (S2). As will be understood, the matching (S2) is not required in every case, and other processing such as image recognition may be performed instead, based on the characteristics of the source image obtained at S1.

FIG. 7 is a flowchart showing details of the process S1 shown in FIG. 6. This process is performed on the assumption that a source image and a destination image are matched at S2. Thus, a source image is first hierarchized using a critical point filter (S10) so as to obtain a series of source hierarchical images. Then, a destination image is hierarchized in the similar manner (S11) so as to obtain a series of destination hierarchical images. The order of S10 and S11 in the flow is arbitrary, and the source image and the destination image can be generated in parallel. It may also be possible to process a number of source and destination images as required by subsequent processes.

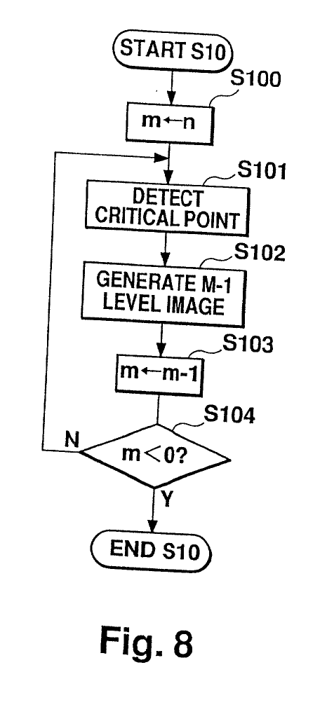

FIG. 8 is a flowchart showing details of the process at S10 shown in FIG. 7. Suppose that the size of the original source image is 2ⁿ×2ⁿ. Since source hierarchical images are sequentially generated from an image with a finer resolution to one with a coarser resolution, the parameter m which indicates the level of resolution to be processed is set to n (S100). Then, critical points are detected from the images p^{(m,0)}, p^{(m,1)}, p^{(m,2)} and p^{(m,3)} of the m-th level of resolution, using a critical point filter (S101), so that the images p^{(m-1,0)}, p^{(m-1,1)}, p^{m-1,2)} and p^{(m-1,3)} of the (m−1)th level are generated (S102). Since m=n here, p^{(m,0)}=p^{(m,1)}=p^{(m,2)}=p^{(m,3)}=p⁽ⁿ⁾ holds and four types of subimages are thus generated from a single source image.

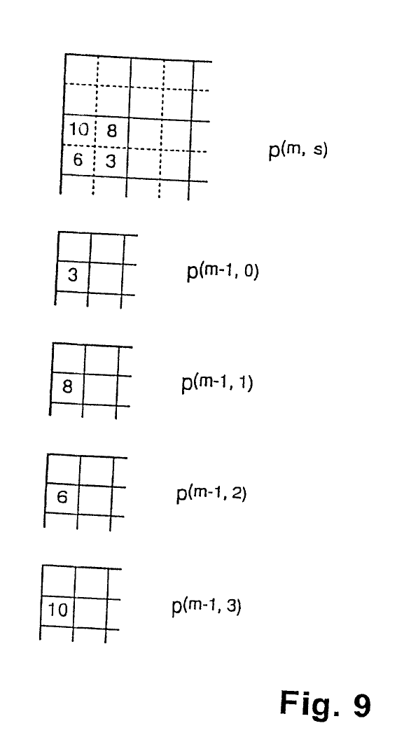

FIG. 9 shows correspondence between partial images of the m-th and those of (m−1)th levels of resolution. Referring to FIG. 9, respective numberic values shown in the figure represent the intensity of respective pixels. p^{(m,s)} symbolizes any one of four images p^{(m,0)} through p^{(m,3)}, and when generating p^{(m-1,0)}, p^{(m,0)} is used from p^{(m,s)}. For example, as for the block shown in FIG. 9, comprising four pixels with their pixel intensity values indicated inside, images p^{(m-1,0)}, p^{(m-1,1)},p^{(m-1,2)} and p^{(m-1,3)} acquire “3”, “8”, “6” and “10”, respectively, according to the rules described in [1.2]. This block at the m-th level is replaced at the (m−1)th level by respective single pixels thus acquired. Therefore, the size of the subimages at the (m−1)th level is 2^{m-1}×2^{m-1}.

After m is decremented (S103 in FIG. 8), it is ensured that m is not negative (S104). Thereafter, the process returns to S101, so that subimages of the next level of resolution, i.e., a next coarser level, are generated. The above process is repeated until subimages at m=0 (0−th level) are generated to complete the process at S10. The size of the subimages at the 0−th level is 1×1.

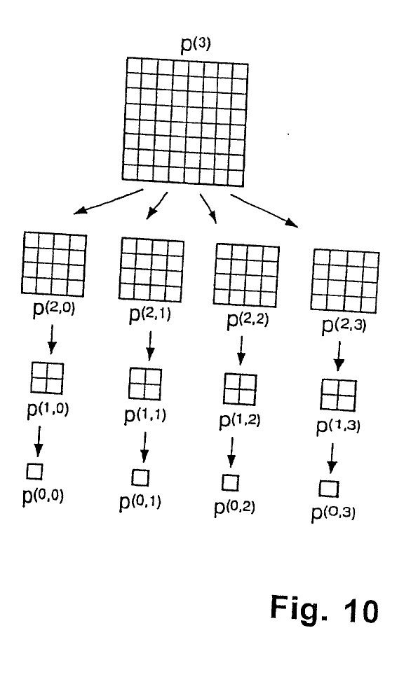

FIG. 10 shows source hierarchical images generated at S10 in the case of n=3. The initial source image is the only image common to the four series followed. The four types of subimages are generated independently, depending on the type of critical point. Note that the process in FIG. 8 is common to S11 shown in FIG. 7, and that destination hierarchical images are generated through a similar procedure. Then, the process at S1 in FIG. 6 is completed.

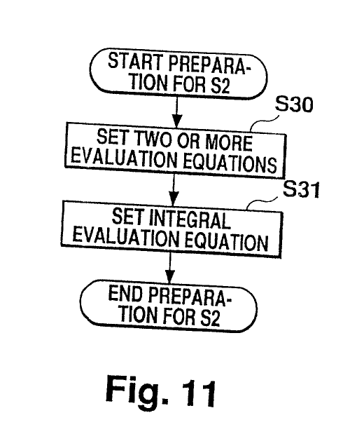

In this base technology, in order to proceed to S2 shown in FIG. 6 a matching evaluation is prepared. FIG. 11 shows the preparation procedure. Referring to FIG. 11, a plurality of evaluation equations are set (S30). The evaluation equations may include the energy C_{f}^{(m,s)} concerning a pixel value, introduced in [1.3.2.1], and the energy D_{f}^{(m,s)} concerning the smoothness of the mapping introduced in [1.3.2.2]. Next, by combining these evaluation equations, a combined evaluation equation is set (S31). Such a combined evaluation equation may be λC_{(i,j)}^{(m,s)}+D_{f}^{(m,s)}. Using η introduced in [1.3.2.2], we have

ΣΣ(λC_{(i,j)}^{(m,s)}+ηE₀_{_{(i,j)}}^{(m,s)}+E₁_{_{(i,j)}}^{(m,s)}) (52)

In the equation (52) the sum is taken for each i and j where i and j run through 0, 1, . . . , 2⁻¹. Now, the preparation for matching evaluation is completed.

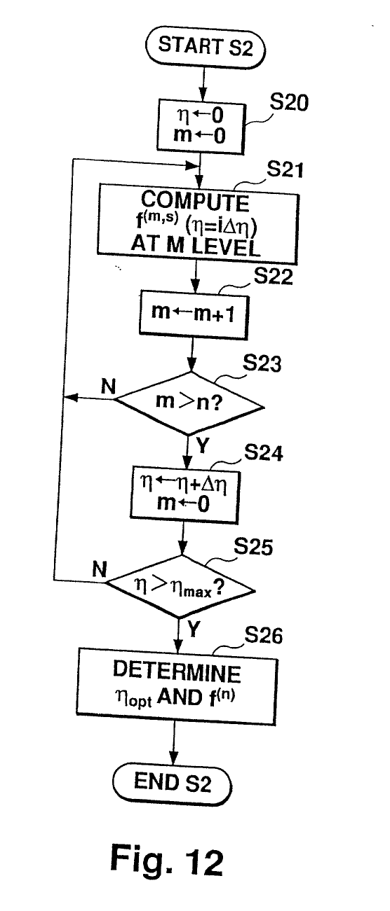

FIG. 12 is a flowchart showing the details of the process of S2 shown in FIG. 6. As described in [1], the source hierarchical images and destination hierarchical images are matched between images having the same level of resolution. In order to detect global correspondence correctly, a matching is calculated in sequence from a coarse level to a fine level of resolution. Since the source and destination hierarchical images are generated using the critical point filter, the location and intensity of critical points are stored clearly even at a coarse level. Thus, the result of the global matching is superior to conventional methods.

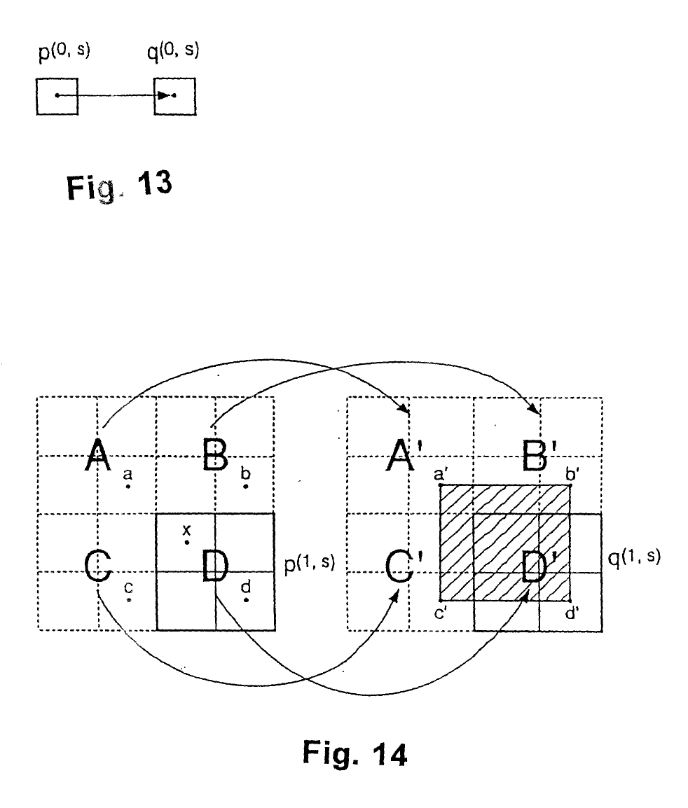

Referring to FIG. 12, a coefficient parameter η and a level parameter m and set to 0 (S20). Then, a matching is computed between the four subimages at the m-th level of the source hierarchical images and those of the destination hierarchical images at the m-th level, so that four types of submappings f^{(m,s)} (s=0, 1, 2, 3) which satisfy the BC and minimize the energy are obtained (S21). The BC is checked by using the inherited quadrilateral described in [1.3.3]. In that case, the submappings at the m-th level are constrained by those at the (m−1)th level, as indicated by the equations (17) and (18). Thus, the matching computed at a coarser level of resolution is used in subsequent calculation of a matching This is called a vertical reference between different levels. If m=0, there is no coarser level and this exceptional case will be described using FIG. 13.

A horizontal reference within the same level is also performed. As indicated by the equation (20) in [1.3.3], f^{(m,3)}, f^{(m,2)} and f^{(m,1)} are respectively determined so as to be analogous to f^{(m,2)}, f^{(m,1)} and f^{(m,0)}. This is because a situation in which the submappings are totally different seems unnatural even though the type of critical points differs so long as the critical points are originally included in the same source and destination images. As can been seen from the equation (20), the closer the submappings are to each other, the smaller the energy becomes, so that the matching is then considered more satisfactory.

As for f^{(m,0)}, which is to be initially determined, a coarser level by one may be referred to since there is no other submapping at the same level to be referred to as shown in the equation (19). In this base technology, however, a procedure is adopted such that after the submappings were obtained up to f^{(m,3)}, f^{(m,0)} is recalculated once utilizing the thus obtained subamppings as a constraint. This procedure is equivalent to a process in which s=4 is substituted into the equation (20) and f^{(m,4)} is set to f^{(m,0)} anew. The above process is employed to avoid the tendency in which the degree of association between f^{(m,0)} and f^{(m,3)} becomes too low. This scheme actually produced a preferable result. In addition to this scheme, the submappings are shuffled in the experiment as described in [1.7.1], so as to closely maintain the degrees of association among submappings which are originally determined independently for each type of critical point. Furthermore, in order to prevent the tendency of being dependent on the starting point in the process, the location thereof is changed according to the value of s as described in [1.7].

FIG. 13 illustrates how the submapping is determined at the 0-th level. Since at the 0-th level each sub-image is constituted by a single pixel, the four submappings f^{(0,s)} are automatically chosen as the identity mapping. FIG. 14 shows how the submappings are determined at the first level. At the first level, each of the sub-images is constituted of four pixels, which are indicated by solid lines. When a corresponding point (pixel) of the point (pixel) x in p^{(1,s)} is searched within q^{(1,s)}, the following procedure is adopted:

1. An upper left point a, an upper right point b, a lower left point c and a lower right point d with respect to the point x are obtained at the first level of resolution.

2. Pixels to which the points a to d belong at a coarser level by one, i.e., the 0-th level, are searched. In FIG. 14, the points a to d belong to the pixels A to D, respectively. However, the pixels A to C are virtual pixels which do not exist in reality.

3. The corresponding points A′ to D′ of the pixels A to D, which have already been defined at the 0-th level, are plotted in q^{(1,s)}. The pixels A′ to C′ are virtual pixels and regarded to be located at the same positions as the pixels A to C.

4. The corresponding point a′ to the point a in the pixel A is regarded as being located inside the pixel A′, and the point a′ is plotted. Then, it is assumed that the position occupied by the point a in the pixel A (in this case, positioned at the lower right) is the same as the position occupied by the point a′ in the pixel A′.

5. The corresponding points b′ to d′ are plotted by using the same method as the above 4 so as to produce an inherited quadrilateral defined by the points a′ to d′.

6. The corresponding point x′ of the point x is searched such that the energy becomes minimum in the inherited quadrilateral. Candidate corresponding points x′ may be limited to the pixels, for instance, whose centers are included in the inherited quadrilateral. In the case shown in FIG. 14, the four pixels all become candidates.

The above described is a procedure for determining the corresponding point of a given point x. The same processing is performed on all other points so as to determine the submappings. As the inherited quadrilateral is expected to become deformed at the upper levels (higher than the second level), the pixels A′ to D′ will be positioned apart from one another as shown in FIG. 3.

Once the four submappings at the m-th level are determined in this manner, m is incremented (S22 in FIG. 12). Then, when it is confirmed that m does not exceed n (S23), return to S21. Thereafter, every time the process returns to S21, submappings at a finer level of resolution are obtained until the process finally returns to S21 at which time the mapping f⁽ⁿ⁾ at the n-th level is determined. This mapping is denoted as f⁽ⁿ⁾ (η=0) because it has been determined relative to η=0.

Next, to obtain the mapping with respect to other different η, η is shifted by Δη and m is reset to zero (S24). After confirming that new η does not exceed a predetermined search-stop value ηₘₐₓ (S25), the process returns to S21 and the mapping f⁽ⁿ⁾ (η=Δη) relative to the new η is obtained. This process is repeated while obtaining f⁽ⁿ⁾ (η=iΔη)(i=0,1, . . . ) at S21. When η exceeds ηₘₐₓ, the process proceeds to S26 and tie optimal η=ηₒₚₜ is determined using a method described later, so as to let f⁽ⁿ⁾ (η=ηₒₚₜ) be the final mapping f⁽ⁿ⁾.

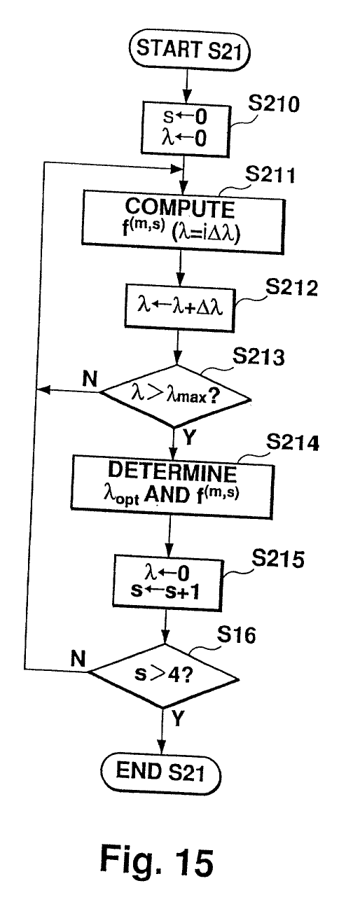

FIG. 15 is a flowchart showing the details of the process of S21 shows in FIG. 12. According to this flowchart, the submappings at the m-th level are determined for a certain predetermined η. In this base technology, when determining the mappings, the optimal λ is defined independently for each submapping.

Referring to FIG. 15, s and λ are first reset to zero (S210). Then, obtained is the submapping f^{(m,s)} that minimizes the energy with respect to the then λ (and, implicitly, η) (S211), and the thus obtained submapping is denoted as f^{(m,s)} (λ=0). In order to obtain the mapping with respect to other different λ, is shifted by Δλ. After confirming that the new λ does not exceed a predetermined search-stop value λₘₐₓ (S213), the process returns to S211 and the mapping f^{(m,s)} (λ=Δλ) relative to the new λ is obtained. This process is repeated while obtaining f^{(m,s)} (λ=iΔλ) (i=0, 1, . . . ). When λ exceeds λₘₐₓ, the process proceeds to S214 and the optimal λ=λₒₚₜ is determined, so as to let f⁽ⁿ⁾ (λ=λₒₚₜ) be the final mapping f^{(m,s)} (S214).

Next, in order to obtain other submappings at the same level, λ is reset to zero and s is incremented (S215). After confirming that s does not exceed 4 (S216), return to S211. When s=4, f^{(m,0)} is renewed utilizing f^{(m,3)} as described above and a submapping at that level is determined.

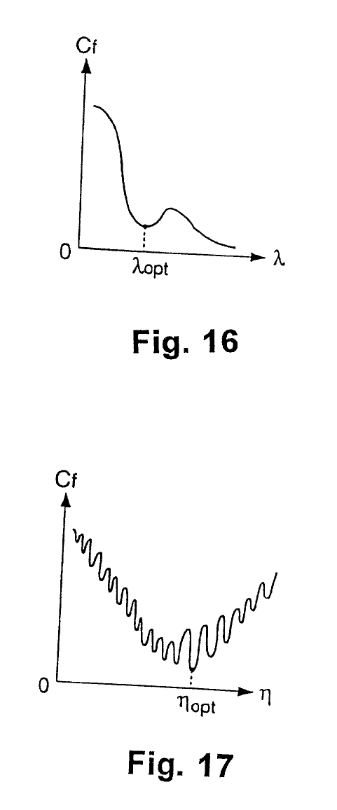

FIG. 16 shows the behavior of the energy C_{f}^{(m,s)} corresponding to f^{(m,s)} (λ=iΔλ) (i=0, 1, . . . ) for a certain m and s while varying λ. As described in [1.4], as λ increases, C_{f}^{(m,s)} normally decreases but changes to increase after λ exceeds the optimal value. In this base technology, λ in which C_{f}^{(m,s)} becomes the minima is defined as λₒₚₜ. As observed in FIG. 16, even if C_{f}^{(m,s)} begins to decrease again in the range λ>λₒₚₜ, the mapping will not be as good. For this reason, it suffices to pay attention to the first occurring minima value. In this base technology, λₒₚₜ is independently determined for each submapping including f⁽ⁿ⁾.

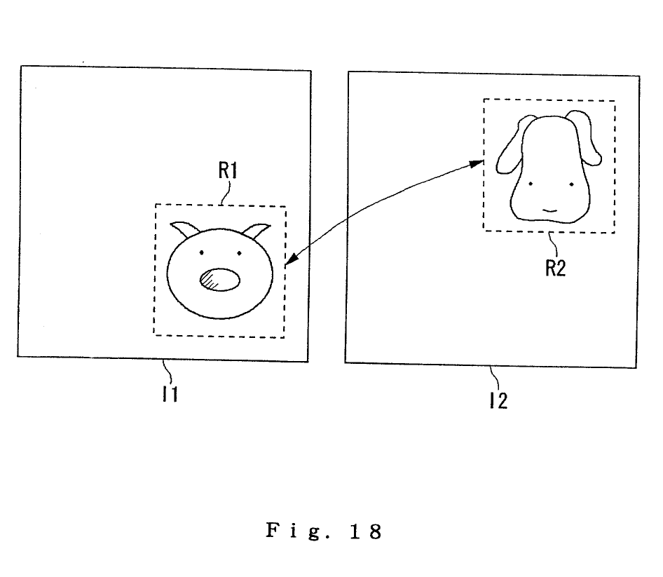

FIG. 17 shows the behavior of the energy C_{f}⁽ⁿ⁾ corresponding to f⁽ⁿ⁾ (η=iΔη) (i=0, 1, . . . ) while varying η. Here too, C_{f}⁽ⁿ⁾ normally decreases as η increases, but C_{f}⁽ⁿ⁾ changes to increase after η exceeds the optimal value. Thus, η in which C_{f}⁽ⁿ⁾ becomes the minima is defined as ηₒₚₜ. FIG. 17 can be considered as an enlarged graph around zero along the horizontal axis shown in FIG. 4. Once ηₒₚₜ is determined, f⁽ⁿ⁾ can be finally determined.

As described above, this base technology provides various merits. First, since there is no need to detect edges, problems in connection with the conventional techniques of the edge detection type are solved. Furthermore, prior knowledge about objects included in an image is not necessitated, thus automatic detection of corresponding points is achieved. Using the critical point filter, it is possible to preserve intensity and locations of critical points even at a coarse level of resolution, thus being extremely advantageous when applied to object recognition, characteristic extraction, and image matching. As a result, it is possible to construct an image processing system which significantly reduces manual labor.

Some further extensions to or modifications of the above-described base technology may be made as follows:

(1) Parameters are automatically determined when the matching is computed between the source and destination hierarchical images in the base technology. This method can be applied not only to the calculation of the matching between the hierarchical images but also to computing the matching between two images in general.

For instance, an energy E₀ relative to a difference in the intensity of pixels and an energy E₁ relative to a positional displacement of pixels between two images may be used as evaluation equations, and a linear sum of these equations, i.e., Eₜₒₜ=αE₀+E₁, may be used as a combined evaluation equation. While paying attention to the neighborhood of the extrema in this combined evaluation equation, α is automatically determined. Namely, mappings which minimize Eₜₒₜ are obtained for various α's. Among such mappings, α at which Eₜₒₜ takes the minimum value is defined as an optimal parameter. The mapping corresponding to this parameter is finally regarded as the optimal mapping between the two images.

Many other methods are available in the course of setting up evaluation equations. For instance, a term which becomes larger as the evaluation result becomes more favorable, such as E₁ and 1/E₂, may be employed. A combined evaluation equation is not necessarily a linear sum, but an n-powered sum (n=2, ½, -1, -2, etc.), a polynomial or an arbitrary function may be employed when appropriate.

The system may employ a single parameter such as the above α, two parameters such as η and λ as in the base technology, or more than two parameters. When there are more than three parameters used, they may be determined while changing one at a time.

(2) In the base technology, a parameter is determined in a two-step process. That is, in such a manner that a point at which C_{f}^{(m,s)} takes the minima is detected after a mapping such that the value of the combined evaluation equation becomes minimum is determined. However, instead of this two-step processing, a parameter may be effectively determined, as the case may be, in a manner such that the minimum value of a combined evaluation equation becomes minimum. In this case, αE₀+βE₁, for example, may be used as the combined evaluation equation, where α+β=1 may be imposed as a constraint so as to equally treat each evaluation equation. The automatic determination of a parameter is effective when determining the parameter such that the energy becomes minimum.

(3) In the base technology, four types of submappings related to four types of critical points are generated at each level of resolution. However, one, two, or three types among the four types may be selectively used. For instance, if there exists only one bright point in an image, generation of hierarchical images based solely on f^{(m,3)} related to a maxima point can be effective to a certain degree. In this case, no other submapping is necessary at the same level, thus the amount of computation relative on s is effectively reduced.

(4) In the base technology, as the level of resolution of an image advances by one through a critical point filter, the number of pixels becomes 1/4. However, it is possible to suppose that one block consists of 3×3 pixels and critical points are searched in this 3×3 block, then the number of pixels will be 1/9 as the level advances by one.

(5) In the base technology, if the source and the destination images are color images, they would generally first be converted to monochrome images, and the mappings then computed. The source color images may then be transformed by using the mappings thus obtained. However, as an alternate method, the submappings may be computed regarding each RGB component.

Preferred Embodiments Concerning Image-effect

An image-effect technology utilizing the above base technology and according to an embodiment of the invention will now be described with reference to FIGS. 18-20. In this embodiment, generation of a morphing or motion pictures by image matching between two key frames is performed. In combination with the above-described base technology, very smooth motion pictures may be generated with relatively few key frames or with key frames that are very different from each other, such that, this technology also provides high data compression for motion pictures.

FIG. 18 shows a first image I1 and a second image I2, which represent key frames. A user of an image-effect apparatus 10 (as described below with reference to FIG. 20), sets a first region R1 in the first image I1 and a second region R2 in the second image I2 that are meant to correspond to each other. That is, the user instructs the image-effect apparatus 10 that the first region R1 should correspond to the second region R2. In the base technology, in which this kind of instruction is not made, it is possible to match regions that should correspond to each other very quickly and automatically, however, when regions that should correspond are in very different positions in each image, or when such regions are very different images or objects, it may be more effective to set regions as described in this embodiment. Furthermore, when the images include many objects or parts that resemble one another such as bounded parts, there may be mismatching in the correspondence between objects or parts of the two images. In such a case, it may also be more effective to set regions as described in this embodiment.

In this embodiment, matching between the first image I1 and the second image I2 is performed using an internal constraint process that constrains the first region R1 to be more likely to correspond to the second region R2 and vice versa. In the following, three possible modes for the internal constraint process are described as examples, however, other internal constraints may also be applied.

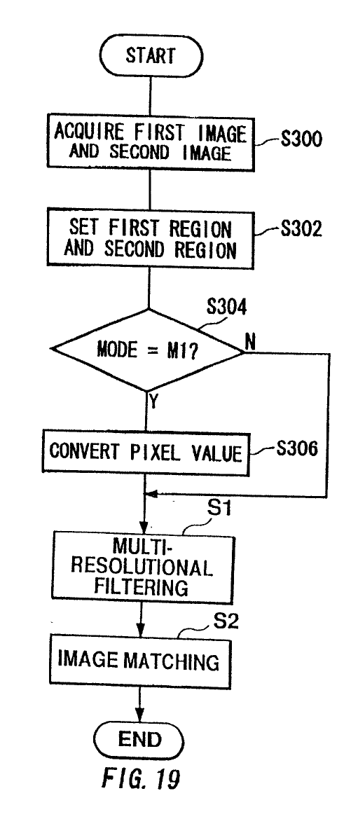

FIG. 19 is a flowchart of a procedure which may be performed by the image-effect apparatus 10. The image-effect apparatus 10 acquires the first image I1 and the second image I2 (S300). The user then sets the first region R1 within the first image I1 and the second region R2 within the second image I2, using a pointing device or the like (S302). Next, the mode of the internal constraint process is determined (S304). The mode may be set by the user or determined by the image-effect apparatus 10. In this embodiment, three modes are defined as examples of the internal constraint process:

Mode M1: In this mode, the internal constraint process includes changing an attribute or attributes of pixels inside or outside of the first region R1 and the second region R2.

Mode M2: In this mode, the internal constraint process includes awarding a penalty when a pixel inside of either one of the first region R1 and the second region R2 corresponds to a pixel outside of the corresponding first region R1 or second region R2, and an energy computation for the matching described in the base technology is performed with the penalty being taken into consideration.

Mode M3: In this mode, the internal constraint process includes limiting a pixel-by-pixel correspondence at a coarser resolution level so that a pixel inside of the first region R1 and a pixel inside of the second region R2 are likely to correspond to each other at a finer resolution level.

In case of the Mode M1

At 304, if the mode is determined to be mode M1, the process proceeds to 306.

At 306, pixel values are used as the attribute of pixels that are changed by the internal constraint process. As an example, the pixels outside of the first region R1 and the second region R2 may be changed to a single color, blue for example, by chromakey processing. The color of the single color is preferably selected so that the color is different from the color of the pixels inside of the first region R1 and the second region R2. With this operation, pixels inside of the first region R1 will generally correspond well with the pixels inside of the second region R2. Further, pixels outside of the first region R1 and the second region R2 will be masked by a blue color or the like such that the pixels outside of the first region R1 are likely to correspond to the pixels outside of the second region R2.

If, even after this processing, one of the pixels within the first image I1 has a correspondence with a plurality of pixels within the second image I2, or vice versa, the matching process can be set such that the correspondence between pixels inside of the first region R1 and the second region R2 will be more important than that of pixels outside of the first region R1 and the second region R2. Therefore, priority is given to a result of a first operation involving matching pixels inside of the regions R1 and R2 over a result of a second operation involving matching of pixels outside of the regions R1 and R2. Then, if there is an overlapped result between the first operation and the second operation, the result of the first operation will be selected. After this internal constraint process is executed, the multiresolutional filtering (S1) and the image matching (S2) as shown in FIG. 6 are performed.

Prior to describing the modes M2 and M3, a structure of the image-effect apparatus 10 according to an embodiment of the invention will be described with reference to FIG. 20. The image-effect apparatus 10 includes an image input unit 12, a region setting unit 32, a matching processor 14, a pixel value converter 30, a corresponding point file storage unit 16 and a communication unit 18. The image input unit 12 acquires the first image I1 and the second image I2 from an external storage device, a camera, a network or the like. The region setting unit 32 receives a user's instruction and sets the regions within the first image. I1 and the second image I2 accordingly. The matching processor 14 performs a matching computation based on the selected regions and using the base technology or other matching technologies to generate a corresponding point file F. In this embodiment, the pixel value converter 30 is provided between the image input unit 12 and the matching processor 14. When mode M1 is selected, the pixel value converter 30 converts the pixel value of pixels in the images before the matching computation process. When mode M2 or M3 is selected, the converter 30 does not convert the pixel value of pixels in the images and simply passes the data to the matching processor 14. The corresponding point file storage unit 16 stores the corresponding point file F generated by the matching processor 14. With the above-described structure, the matching processor 14 provides a detailed matching in accordance with the user's instruction.

The corresponding point file F may be used to generate intermediate images between the first image I1 and the second image I2. As is described in the base technology above, any number of intermediate images between the first image I1 and the second image I2 can be generated by the interpolation of corresponding points of those images. Thus, by storing the first image I1, the second image I2 and the corresponding point file F, a morphing or smooth motion picture between the first image I1 and the second image I2 can be generated. Since the corresponding point file F can be quite small, this technology enables high compression rates for motion pictures. The communication unit 22 may send out the first image I1, the second image I2 and the corresponding point file F to an external unit 100 via a transmission infrastructure such as a network or the like, for example, upon a request from the external unit 100.

The external unit 100 includes a communication unit 102, an intermediate image generator 104, and a display unit 106. The communication unit 102 receives the first image I1, the second image I2 and the corresponding point file F from the image-effect apparatus 10. The intermediate image generator 104 generates one or more intermediate images between the first image I1 and the second image I2 based on the corresponding point file F.

The intermediate image generator 104 generates intermediate images based on a user's request or other factors. Then, the intermediate images are sent to the display unit 106. The display unit 106 then displays the first image I1, the intermediate images, and the second image I2 as a motion picture. The display unit 106 may also adjust the timing of displaying the intermediate images to provide either a motion picture or a morphing between the first image I1 and the second image I 2. In this embodiment, the external unit 100 is able to automatically display motion pictures by receiving only a relatively small amount of data made up of the first image I1, the second image I2 and the corresponding point file F. In an alternate embodiment, the image-effect apparatus 10 may also include the intermediate image generator 104 and the display unit 106.

In case of the Mode M2

In this mode, in order to reduce correspondence between pixels inside of either one of the first region R1 and the second region R2 and pixels outside of the other one of the first region R1 and the second region R2, the energy defined in the description of the base technology is utilized. As an example, a third term may be added to equation (9). The original equation (9) is defined in light of relative positions between corresponding pixels, and a third term would become a basic part of the matching based on whether the corresponding pixels are inside of each region or not.

Now, assuming that the third term is E_{R}, the E_{R} can be defined as having a large value when one of the corresponding pixels is inside of the region and the other of the corresponding pixels is outside of the region, and being zero when both corresponding pixels are inside or outside of the regions. Thus, this embodiment is different from the base technology in that the E_{R} is introduced when setting evaluation equations (S30 and S31) prior to the matching process. After this internal constraint process is executed, the multiresolutional filtering (S1) and the image matching (S2) shown in FIG. 6 are performed.

In this mode M2, the pixel value converter unit 30 does not convert the pixel values of the images. The matching processor 14 evaluates the matching result by changing the value of E_{R} based on whether the evaluated pixels are both inside of the regions R1 and R2, both outside of the regions R1 and R2, or one is inside one region and the other is outside of the other region.

In case of the Mode M3

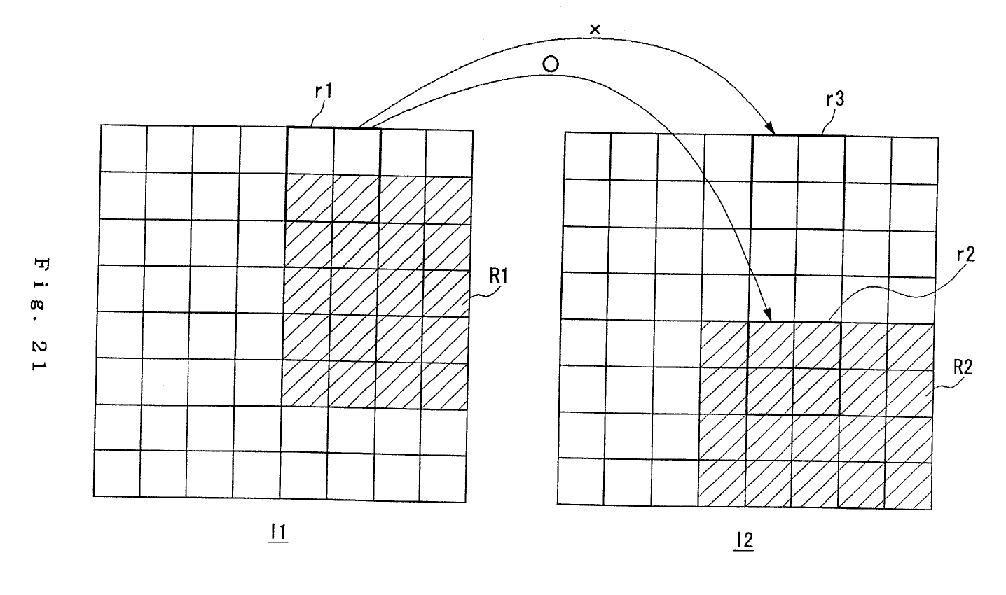

FIG. 21 is used to explain the internal constraint process for the mode M3. In FIG. 21, both the first image I1 and the second image I2 are at the m-th level, which is the finest level. The first region R1 and the second region R2 are shown having hatched lines. Regions r1, r2 and r3, each including four pixels, represent a single pixel at the (m−1)th level, which is one level coarser than the m-th level. In this mode M3, a pixel-by-pixel correspondence at the (m−1)th level is limited so that pixels inside of the first region R1 are likely to correspond to pixels inside of the second region R2 at the m-th level.

In the case shown in FIG. 21, the region r1 of the first image I1 at the (m−1)th level includes pixels which would be inside of the first region R1 at the m-th level. The region r2 of the second image I2 at the (m−1)th level includes pixels which would be inside of the second region R2 at the m-th level. Thus, a correspondence between the region r1 and the region r2 is allowed. On the other hand, the region r3 of the second image I2 at the (m−1)th level does not include pixels which would be inside of the second region R2. Thus, a correspondence between the region r1 and the region r3 is not allowed.

Similarly, as long as a pixel within the first image I1 at a coarser resolution level includes a pixel which would be inside of the first region R1 at the m-th level, the pixel at the coarser level has to correspond to a pixel within the second image I2 at the coarser level that includes a pixel which would be inside of the second region R2 at the m-th level. As resolution of the image becomes coarser, each pixel within the images at that resolution level becomes large. Thus, each pixel within the first image I1 tends to include a pixel which would be inside of the region R1 at the m-th level and each pixel within the second image I2 tends to include a pixel which would be inside of the region R2 at the m-th level.

On the other hand, a limitation can also be provided so that when a pixel within the first image I1 at a coarser resolution level does not include a pixel which would be inside of the first region R1 at the m-th level, the pixel has to correspond to a pixel within the second image I2 at the coarser level that does not include a pixel which would be inside of the second region R2 at the m-th level. If a conflict occurs between these limitations, for example, one pixel within the first image I1 corresponds to a plurality of pixels in the second image I2, the limitations may be loosened.

As above, after the internal constraint process is implemented, the multiresolutional filtering (S1) and the image matching (S2) as shown in FIG. 6 are performed.

In this mode M3, the pixel value converter 30 does not convert the pixel values of the images. The matching processor 14 evaluates the energy only when the target pair of pixels satisfies the above limitations. In another example, the matching processor 14 may evaluate a pair of pixels that does not satisfy the above limitation by applying an energy value to which a penalty is awarded as in the mode M2.

A preferred embodiment according to the present invention has now been described, however, modifications to the embodiment may be made. Examples of such modifications are described hereinafter.

The region R1 and the region R2 are not necessarily rectangular, these regions may be a circle, an ellipse, or any kind of shape provided that the selected areas are recognized or set as regions.

In the above embodiment, mode M2, a new term E_{R} is added to equation (9). However, any operation can be done provided that the penalty for the energy is sufficient. For example, in the case where a minimum energy indicates a better match, a large number can be multiplied by the value of the original equation (9) as the penalty.

Further, the modes M1, M2, and M3 can be arbitrarily combined or other modes may be used alone or in combination.

Although the present invention has been described by way of exemplary embodiments, it should be understood that many changes and substitutions may be made by those skilled in the art without departing from the spirit and the scope of the present invention which is defined by the appended claims.

What is claimed is:

1. An image-effect method comprising:
acquiring a first image and a second image;
setting a first region within said first image and a second region within said second image; and
detecting a matching between said first image and said second image using an internal constraint process for constraining said first region to be more likely to correspond to said second region.

2. A method according to claim 1, wherein said detecting comprises performing a pixel-by-pixel matching computation between said first image and said second image.

3. A method according to claim 2, wherein said pixel-by-pixel matching computation is based on correspondence between a first critical point and a second critical point, wherein said first critical point and said second critical point are detected through two-dimensional searches on said first image and said second image, respectively.

4. A method according to claim 3, wherein said detecting further comprises obtaining multiresolutional images of said first image and said second image by respectively extracting said first critical point and said second critical point, and performing said pixel-by-pixel matching computation by beginning at a courser resolution level and then performing a pixel-by-pixel matching computation at a same resolution level while inheriting a result of a pixel-by-pixel matching computation at a different resolution level to acquire a pixel-by-pixel correspondence at a finest resolution level.

5. A method according to claim 1, further comprising generating an intermediate image between said first image and said second image by performing an interpolation computation.

6. A method according to claim 1, wherein said internal constraint process comprises changing an attribute of pixels inside of said first region and said second region such that said attribute of pixels inside of said first region and said second region is different from said attribute of pixels outside of said first region and said second region.

7. A method according to claim 1, wherein said internal constraint process comprises changing an attribute of pixels outside of said first region and said second region such that said attribute of pixels outside of said first region and said second region are respectively different from said attribute of pixels inside of said first region and said second region.

8. A method according to claim 1, wherein said internal constraint process comprises awarding a penalty when a pixel inside of said first region corresponds to a pixel outside of said second region, and said detecting comprises performing an energy computation with said penalty being taken into consideration.

9. A method according to claim 1, wherein said internal constraint process comprises awarding a penalty when a pixel inside of said second region corresponds to a pixel outside of said first region, and said detecting comprises performing an energy computation with said penalty being taken into consideration.

10. A method according to claim 4, wherein said internal constraint process comprises limiting a pixel-by-pixel correspondence at a coarser resolution level so that a pixel inside of said first region and a pixel inside of said second region are likely to correspond to each other at a finer resolution level.

11. An image-effect apparatus comprising:
an image input unit which acquires a first image and a second image;
a region setting unit which sets a first region within said first image and a second region within said second image; and
a matching processor which performs a matching computation between said first image and said second image,
wherein said matching processor performs said matching computation using an internal constraint process for constraining said first region to be more likely to correspond to said second region.

12. An apparatus according to claim 11, wherein said matching processor performs said matching computation pixel-by-pixel based on correspondence between a first critical point and a second critical point, said first critical point and said second critical point being detected through two-dimensional searches on said first image and said second image, respectively.

13. An apparatus according to claim 12, wherein said matching processor obtains multiresolutional images of said first image and said second image by respectively extracting said first critical point and said second critical point, and performs said pixel-by-pixel matching computation by beginning at a courser resolution level and then performing a pixel-by-pixel matching computation at a same resolution level while inheriting a result of a pixel-by-pixel matching computation at a different resolution level to acquire a pixel-by-pixel correspondence at a finest resolution level.

14. An apparatus according to claim 11, wherein said matching processor generates a corresponding point file based on said matching computation and said image-effect apparatus further comprises a communication unit which transmits said corresponding point file to an external device.

15. A computer program executable by a computer, said program comprising functions of:
acquiring a first region and a second region respectively set within a first image and a second image; and
detecting matching between said first image and said second image using an internal constraint process for constraining said first region to be more likely to correspond to said second region.
